(19) United States
(12) Patent Application Publication
(10) Pub. No.: US 2025/0159587 A1
(43) Pub. Date: May 15, 2025

(54) TECHNIQUES FOR A REFERENCE SIGNAL FOR ON-DEMAND BROADCAST COMMUNICATIONS

(71) Applicant: QUALCOMM Incorporated, San Diego, CA (US)

(72) Inventors: Hung Dinh LY, San Diego, CA (US); Navid ABEDINI, Basking Ridge, NJ (US)

(21) Appl. No.: 18/505,605

(22) Filed: Nov. 9, 2023

(51) Int. Cl. H04W 48/08; H04L 5/00; H04W 24/08

(52) U.S. Cl. CPC H04W 48/08; H04L 5/0048; H04W 24/08

(57) ABSTRACT

Various aspects of the present disclosure generally relate to wireless communication. In some aspects, a user equipment (UE) may receive a synchronization signal block (SSB) configuration for SSBs that carry first synchronization information. The UE may receive a reference signal indicating second synchronization information that is reduced relative to the first synchronization information. The UE may measure the reference signal to obtain measurement information. The UE may transmit, in association with the measurement information, a communication. The UE may receive, based on the transmission of the communication, an SSB in accordance with the SSB configuration and the measurement of the reference signal. Numerous other aspects are described.

### FIELD OF THE DISCLOSURE

Aspects of the present disclosure generally relate to wireless communication and specifically relate to techniques, apparatuses, and methods for a reference signal for on-demand broadcast communications.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a user equipment (UE) for wireless communication. The UE may include one or more memories and one or more processors coupled to the one or more memories. The one or more processors may be configured to cause the UE to receive a synchronization signal block (SSB) configuration for SSBs that carry first synchronization information. The one or more processors may be configured to cause the UE to receive a reference signal indicating second synchronization information that is reduced relative to the first synchronization information. The one or more processors may be configured to cause the UE to measure the reference signal to obtain measurement information. The one or more processors may be configured to cause the UE to transmit, in association with the measurement information, a communication. The one or more processors may be configured to cause the UE to receive, based on the transmission of the communication, an SSB in accordance with the SSB configuration and the measurement of the reference signal.

Some aspects described herein relate to a network node for wireless communication. The network node may include one or more memories and one or more processors coupled to the one or more memories. The one or more processors may be configured to cause the network node to transmit an SSB configuration for SSBs that carry first synchronization information. The one or more processors may be configured to cause the network node to transmit a reference signal indicating second synchronization information that is reduced relative to the first synchronization information. The one or more processors may be configured to cause the network node to receive, in association with measurement information of the reference signal, a communication. The one or more processors may be configured to cause the network node to transmit, based on the reception of the communication, an SSB, wherein the SSB is in accordance with the SSB configuration and the measurement information.

Some aspects described herein relate to a method of wireless communication performed by a UE. The method may include receiving an SSB configuration for SSBs that carry first synchronization information. The method may include receiving a reference signal indicating second synchronization information that is reduced relative to the first synchronization information. The method may include measuring the reference signal to obtain measurement information. The method may include transmitting, in association with the measurement information, a communication. The method may include receiving, based on the transmission of the communication, an SSB in accordance with the SSB configuration and the measurement of the reference signal.

Some aspects described herein relate to a method of wireless communication performed by a network node. The method may include transmitting an SSB configuration for SSBs that carry first synchronization information. The method may include transmitting a reference signal indicating second synchronization information that is reduced relative to the first synchronization information. The method may include receiving, in association with measurement information of the reference signal, a communication. The method may include transmitting, based on the reception of the communication, an SSB, wherein the SSB is in accordance with the SSB configuration and the measurement information.

Some aspects described herein relate to a non-transitory computer-readable medium that stores a set of instructions for wireless communication by a UE. The set of instructions, when executed by one or more processors of the UE, may cause the UE to receive an SSB configuration for SSBs that carry first synchronization information. The set of instructions, when executed by one or more processors of the UE, may cause the UE to receive a reference signal indicating second synchronization information that is reduced relative to the first synchronization information. The set of instructions, when executed by one or more processors of the UE, may cause the UE to measure the reference signal to obtain measurement information. The set of instructions, when executed by one or more processors of the UE, may cause the UE to transmit, in association with the measurement information, a communication. The set of instructions, when executed by one or more processors of the UE, may cause the UE to receive, based on the transmission of the communication, an SSB in accordance with the SSB configuration and the measurement of the reference signal.

Some aspects described herein relate to a non-transitory computer-readable medium that stores a set of instructions for wireless communication by a network node. The set of instructions, when executed by one or more processors of the network node, may cause the network node to transmit an SSB configuration for SSBs that carry first synchronization information. The set of instructions, when executed by one or more processors of the network node, may cause the network node to transmit a reference signal indicating second synchronization information that is reduced relative to the first synchronization information. The set of instructions, when executed by one or more processors of the network node, may cause the network node to receive, in association with measurement information of the reference signal, a communication. The set of instructions, when executed by one or more processors of the network node, may cause the network node to transmit, based on the reception of the communication, an SSB, wherein the SSB is in accordance with the SSB configuration and the measurement information.

Some aspects described herein relate to an apparatus for wireless communication. The apparatus may include means for receiving an SSB configuration for SSBs that carry first synchronization information. The apparatus may include means for receiving a reference signal indicating second synchronization information that is reduced relative to the first synchronization information. The apparatus may include means for measuring the reference signal to obtain measurement information. The apparatus may include means for transmitting, in association with the measurement information, a communication. The apparatus may include means for receiving, based on the transmission of the communication, an SSB in accordance with the SSB configuration and the measurement of the reference signal.

Some aspects described herein relate to an apparatus for wireless communication. The apparatus may include means for transmitting an SSB configuration for SSBs that carry first synchronization information. The apparatus may include means for transmitting a reference signal indicating second synchronization information that is reduced relative to the first synchronization information. The apparatus may include means for receiving, in association with measurement information of the reference signal, a communication. The apparatus may include means for transmitting, based on the reception of the communication, an SSB, wherein the SSB is in accordance with the SSB configuration and the measurement information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example UE in a wireless network.

FIG. 3 is a diagram illustrating an example disaggregated base station architecture in accordance with the present disclosure.

FIG. 4 is a diagram illustrating an example of a synchronization signal (SS) hierarchy, in accordance with the present disclosure.

FIG. 5 is a diagram illustrating an example of an SS block (SSB), in accordance with the present disclosure.

FIG. 6 is a diagram illustrating an example of candidate SSB locations, in accordance with the present disclosure.

FIG. 7 is a diagram illustrating an example of network energy saving, in accordance with the present disclosure.

FIG. 8 is a diagram illustrating an example of multi-carrier operations for on-demand communications, in accordance with the present disclosure.

FIG. 9 is a diagram of an example associated with a reference signal for on-demand broadcast communications, in accordance with the present disclosure.

FIGS. 10A-10E are diagrams of example formats of a reference signal for on-demand broadcast communications, in accordance with the present disclosure.

FIGS. 11A-11B are diagrams of example of formats of a reference signal for on-demand broadcast communications, in accordance with the present disclosure.

FIG. 12 is a diagram of an example associated with reference signal locations for on-demand broadcast communications, in accordance with the present disclosure.

FIG. 13 is a diagram of an example associated with timing for a reference signal for on-demand broadcast communications, in accordance with the present disclosure.

FIG. 14 is a diagram illustrating an example process performed, for example, at a UE or an apparatus of a UE, in accordance with the present disclosure.

FIG. 15 is a diagram illustrating an example process performed, for example, at a network node or an apparatus of a network node, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, a network node may transmit one or more broadcast communications (e.g., a synchronization signal block (SSB), system information, or a system information block (SIB) type 1 (SIB1)) in an “on-demand” manner. For example, the network node may transmit an SSB or SIB1 based on, in response to, or otherwise associated with receiving a request from a user equipment (UE) and/or based on, in response to, or otherwise associated with secondary cell (SCell) activation, among other examples. In such examples, the communication may be referred to as an “on-demand” communication (e.g., an on-demand SSB or an on-demand SIB). Transmitting the broadcast communications in the on-demand manner may conserve energy and/or power of the network node that would have otherwise been used to always transmit the broadcast communications in accordance with a configuration of the broadcast communications.

As described elsewhere herein, the UE may need time domain tracking information, frequency domain tracking information, and/or pathloss information, among other examples, for broadcast communications (e.g., SSBs or SIBs) that are transmitted in response to a trigger (e.g., on-demand broadcast communications), such as an uplink wakeup signal (WUS) communication or a network trigger, among other examples. However, for UEs operating in a radio resource control (RRC) idle mode or an RRC inactive mode, the UE may not have access to such information for non-anchor cells. Additionally, for UEs configured with a carrier aggregation configuration, the UE may not have access to such information for SCells. In some examples, the non-anchor cells or SCells may transmit a reference signal to provide domain tracking information, frequency domain tracking information, and/or pathloss information, among other examples, for the on-demand broadcast communications. However, a timing and/or content of the reference signals is not defined. Additionally, using known reference signals, such as an SSB, for this purpose may consume significant energy and/or power resources of the cells, thereby negating any benefits of the energy saving operations (e.g., the on-demand broadcast transmission operation) performed by the cells.

Various aspects relate generally to a reference signal for on-demand broadcast communications. Some aspects more specifically relate to defining synchronization information carried by the reference signal. In some aspects, the synchronization information carried by the reference signal may be reduced information (e.g., less information) relative to synchronization information carried by an SSB. For example, the reference signal may indicate symbol timing information and/or an identifier of a cell (e.g., a physical cell identifier (PCI)) via which the reference signal is transmitted. Additionally, the reference signal may indicate beam information (e.g., an index of the reference signal) and/or slot timing information. For example, the reference signal may only include a primary synchronization signal (PSS) and a secondary synchronization signal (SSS). In some aspects, the reference signal may further include a tertiary synchronization signal (TSS) that indicates the index of the reference signal and enables the UE to determine slot timing information. In some aspects, the reference signal may not include a physical broadcast channel (PBCH).

In some aspects, the reference signal may use a timing that is otherwise defined, or fixed, for SSBs. For example, an SSB location may be defined for an SSB (e.g., by a wireless communication standard, such as the Third Generation Partnership Project (3GPP)). A network node may transmit, and a UE may receive, the reference signal in at least a portion of the SSB location. For example, time domain locations (e.g., OFDM symbols) may be defined, within an SSB location, for parts (e.g., a PSS, an SSS, and/or a TSS) of one or more reference signals. In some aspects, locations for multiple reference signals may be defined within a single SSB location (e.g., because the reference signal includes reduced synchronization information). In some aspects, the reference signal and the on-demand broadcast communication may be transmitted via the same frequency. In some aspects, a timing of a measurement window for the on-demand broadcast communication may be relative to a measurement window for the reference signal.

Particular aspects of the subject matter described in this disclosure can be implemented to realize one or more of the following potential advantages. In some examples, by transmitting the reference signal, the described techniques can be used to provide time domain tracking information, frequency domain tracking information, and/or pathloss information, among other examples, for on-demand broadcast communications. In some examples, by including reduced synchronization information (e.g., relative to synchronization information typically included in an SSB), the described techniques can be used to ensure that sufficient information for the on-demand broadcast communications is provided to the UE, while also conserving resources (e.g., network resources and/or power resources) that would have otherwise been used to transmit full synchronization information (e.g., all synchronization information typically included in an SSB).

In some aspects, by using (e.g., reusing) a timing that is otherwise defined, or fixed, for SSBs, the described techniques can be used to utilize time resources that may be otherwise allocated for SSBs that are transmitted in an on-demand manner for the reference signal(s). This improves a resource utilization efficiency of the network. In some aspects, by including the TSS in the reference signal, the described techniques can be used to provide beam information and/or slot timing information for the UE. This may improve the performance of a WUS transmitted by the UE (e.g., because the UE may determine slot timing for the cell via which the WUS is transmitted and spatial domain information for the WUS). In some aspects, by transmitting the reference signal and the on-demand broadcast communication via the same frequency, a complexity and/or latency associated with the UE searching for the on-demand broadcast communication (e.g., for the SSB or the SIB) may be reduced (e.g., because the UE may know the frequency via which the on-demand broadcast communication is transmitted).

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the 3GPP. 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

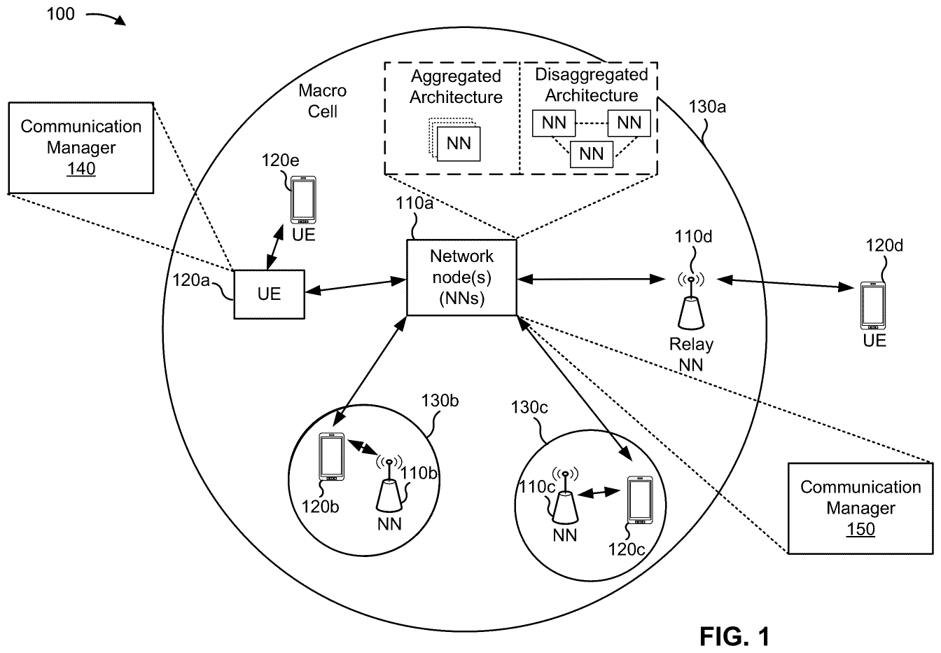

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHZ), FR3 (7.125 GHZ through 24.25 GHz), FR4a or FR4-1 (52.6 GHz through 71 GHZ), FR4 (52.6 GHz through 114.25 GHZ), and FR5 (114.25 GHz through 300 GHz). Although a portion of FR1 is greater than 6 GHz, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, May include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks (RBs), and/or resource elements (REs)), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive an SSB configuration for SSBs that carry first synchronization information; receive a reference signal indicating second synchronization information that is reduced relative to the first synchronization information; and measure the reference signal to obtain measurement information; transmit, in association with the measurement information, a communication; and receive, based on the transmission of the communication, an SSB in accordance with the SSB configuration and the measurement of the reference signal. Additionally, or alternatively, the communication manager 140 may perform one or more other operations described herein.

In some aspects, the network node 110 may include a communication manager 150. As described in more detail elsewhere herein, the communication manager 150 may transmit an SSB configuration for SSBs that carry first synchronization information; transmit a reference signal indicating second synchronization information that is reduced relative to the first synchronization information; and receive, in association with measurement information of the reference signal, a communication; and transmit, based on the reception of the communication, an SSB, wherein the SSB is in accordance with the SSB configuration and the measurement information. Additionally, or alternatively, the communication manager 150 may perform one or more other operations described herein.

As indicated above, FIG. 1 is provided as an example. Other examples may differ from what is described with regard to FIG. 1.

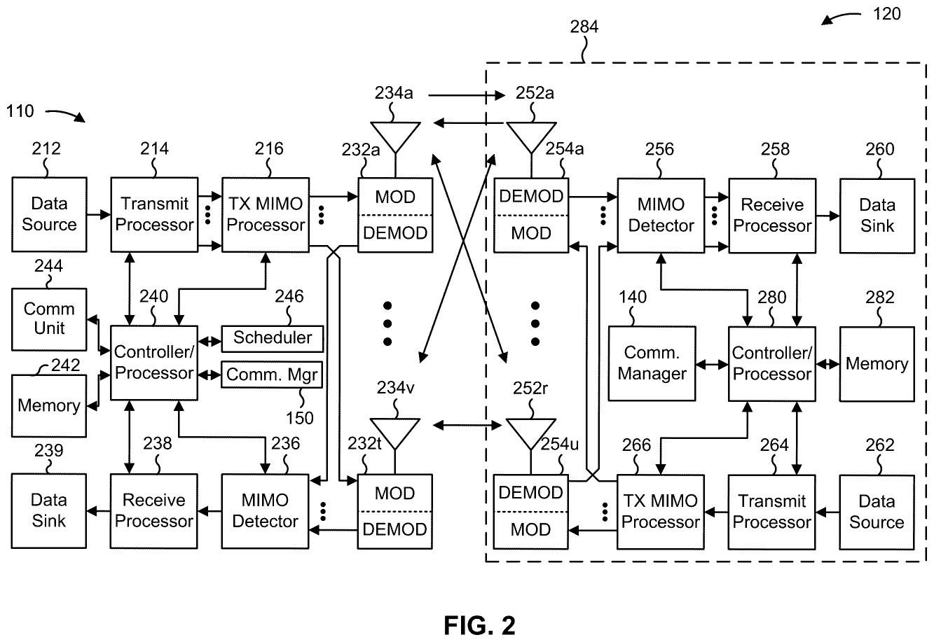

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

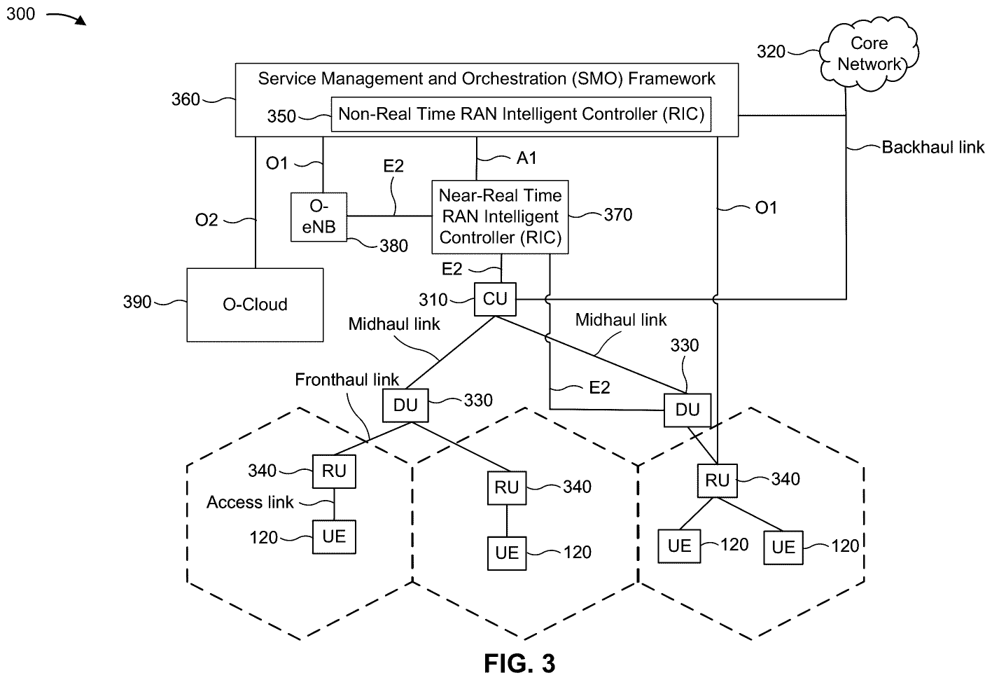

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU-UP units and one or more CU-CP units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

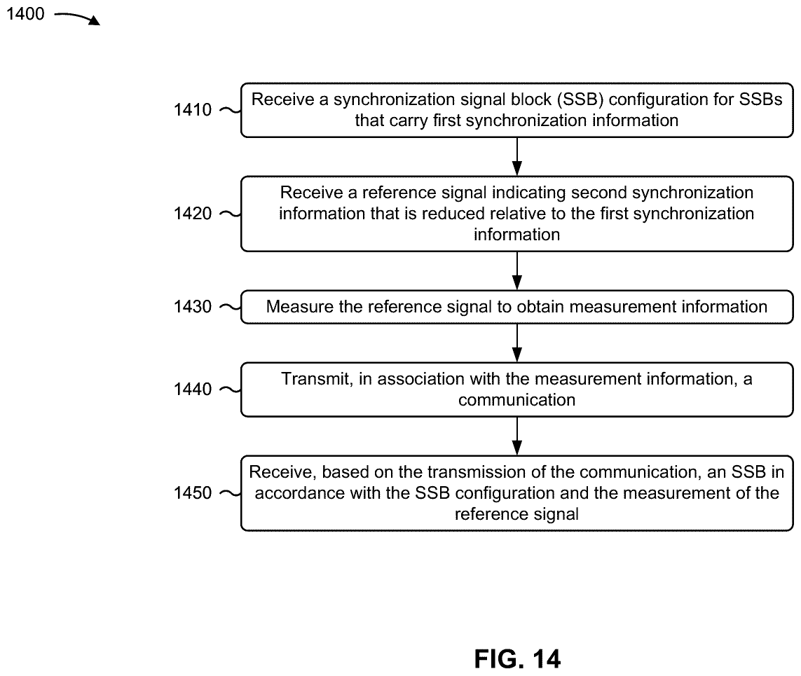

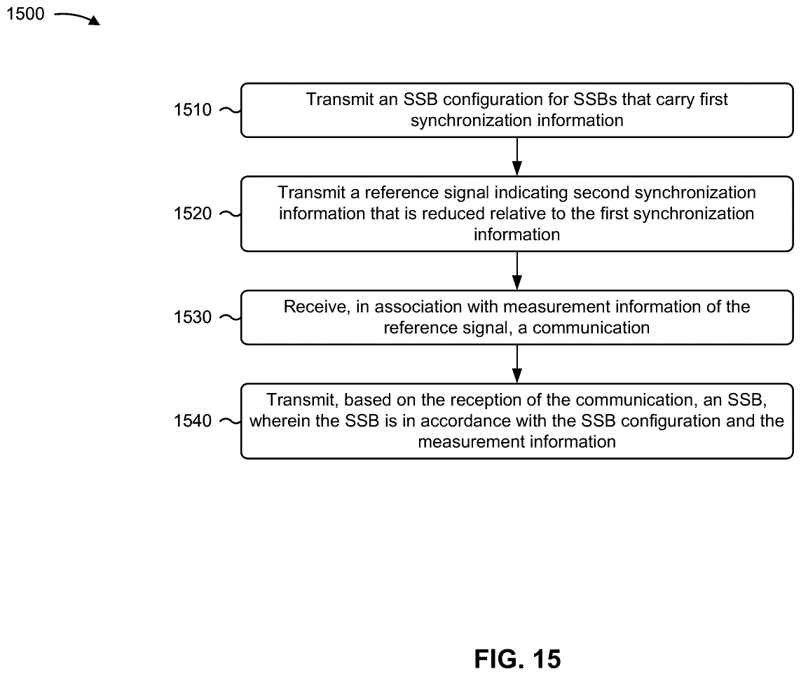

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with a reference signal for on-demand broadcast communications, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 1400 of FIG. 14, process 1500 of FIG. 15, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1400 of FIG. 14, process 1500 of FIG. 15, or other processes as described herein (alone or in conjunction with one or more other processors). In some examples, executing instructions may include running the instructions, converting the instructions, compiling the instructions, and/or interpreting the instructions, among other examples.

In some aspects, the UE 120 includes means for receiving an SSB configuration for SSBs that carry first synchronization information; means for receiving a reference signal indicating second synchronization information that is reduced relative to the first synchronization information; and/or means for measuring the reference signal to obtain measurement information; means for transmitting, in association with the measurement information, a communication; and/or means for receiving, based on the transmission of the communication, an SSB in accordance with the SSB configuration and the measurement of the reference signal. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an SSB configuration for SSBs that carry first synchronization information; means for transmitting a reference signal indicating second synchronization information that is reduced relative to the first synchronization information; and/or means for receiving, in association with measurement information of the reference signal, a communication; and/or means for transmitting, based on the reception of the communication, an SSB, wherein the SSB is in accordance with the SSB configuration and the measurement information. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

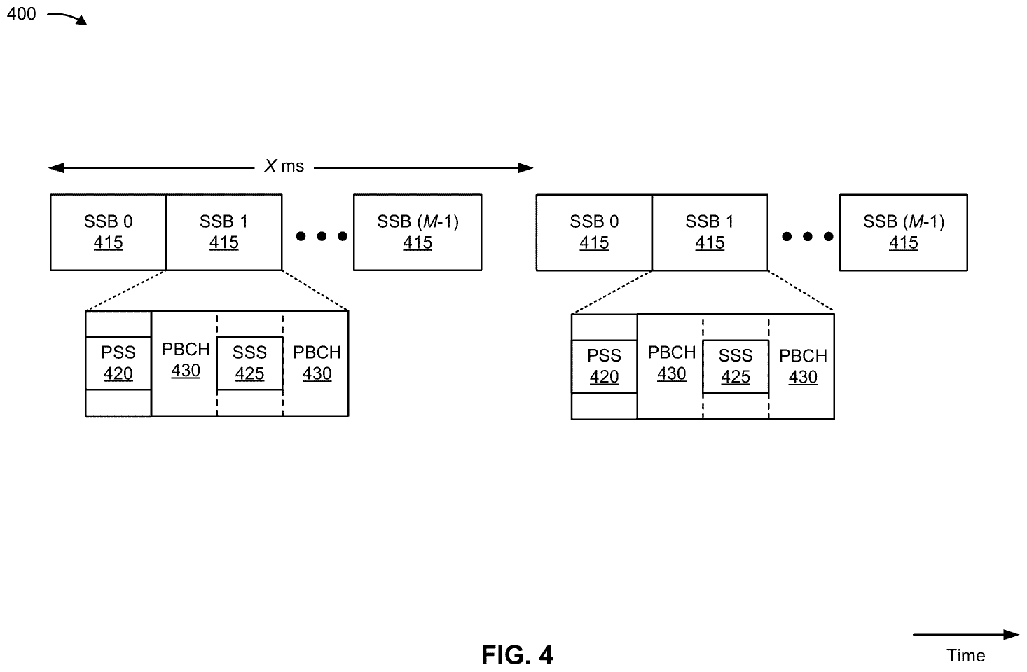

FIG. 4 is a diagram illustrating an example 400 of a synchronization signal (SS) hierarchy, in accordance with the present disclosure. As shown in FIG. 4, the SS hierarchy may include one or more SS blocks (SSBs) 415, shown as SSB 0 through SSB M−1. In some aspects, different SSBs 415 may be beam-formed differently (e.g., transmitted using different beams), and may be used for cell search, cell acquisition, beam management, and/or beam selection (e.g., as part of an initial network access procedure). An the M SSBs 415 may be periodically transmitted by a wireless node (e.g., a network node 110), such as every X milliseconds, as shown in FIG. 4.

In some aspects, an SSB 415 may include resources that carry a primary synchronization signal (PSS) 420, a secondary synchronization signal (SSS) 425, and/or a physical broadcast channel (PBCH) 430. In some aspects, multiple SSBs 415 may be transmitted, and the PSS 420, the SSS 425, and/or the PBCH 430 may be the same across each SSB 415. In some aspects, the SSB 415 may be at least four symbols (e.g., OFDM symbols) in length, where each symbol carries one or more of the PSS 420 (e.g., occupying one symbol), the SSS 425 (e.g., occupying one symbol), and/or the PBCH 430 (e.g., occupying two symbols). In some aspects, an SSB 415 may be referred to as an SS/PBCH block. In some aspects, an SSB 415 (e.g., a PSS 420 and an SSS 425) may be frequency division multiplexed with the PBCH 430.

In some aspects, the symbols of an SSB 415 are consecutive, as shown in FIG. 4. In some aspects, the symbols of an SSB 415 are non-consecutive. Similarly, in some aspects, one or more SSBs 415 may be transmitted in consecutive radio resources (e.g., consecutive symbols) during one or more slots. Additionally, or alternatively, one or more SSBs 415 may be transmitted in non-consecutive radio resources.

In some aspects, an SSB 415 may include an SSB index, which may correspond to a beam used to carry the SSB 415. For example, the SSB index may be indicated via the PBCH 430. A UE 120 may monitor for and/or measure SSBs 415 using different receive (Rx) beams during an initial network access procedure and/or a cell search procedure, among other examples. Based at least in part on the monitoring and/or measuring, the UE 120 may indicate one or more SSBs 415 with a best signal parameter (e.g., a reference signal received power (RSRP) parameter) to a network node 110 (e.g., directly or via one or more other network nodes). The network node 110 and the UE 120 may use the one or more indicated SSBs 415 to select one or more beams to be used for communication between the network node 110 and the UE 120 (e.g., for a random access channel (RACH) procedure). Additionally, or alternatively, the UE 120 may use the SSB 415 and/or the SSB index to determine a cell timing for a cell via which the SSB 415 is received (e.g., a serving cell). For example, the UE 120 may use the SSB index of one or more SSBs 415 to determine a slot timing.

In some examples, a network node 110 may transmit one or more SSBs 415 in an “on-demand” manner. For example, the network node 110 may transmit an SSB based on, in response to, or otherwise associated with receiving a request from the UE 120 (e.g., via an uplink WUS transmission) and/or based on, in response to, or otherwise associated with secondary cell (SCell) activation, among other examples. In such examples, the SSB 415 may be referred to as an “on-demand” SSB. Transmitting the SSBs in the on-demand manner may conserve energy and/or power of the network node 110 that would have otherwise been used to always transmit the SSB 415 in accordance with the configuration of the SSB 415.

As indicated above, FIG. 4 is provided as an example. Other examples may differ from what is described with regard to FIG. 4.

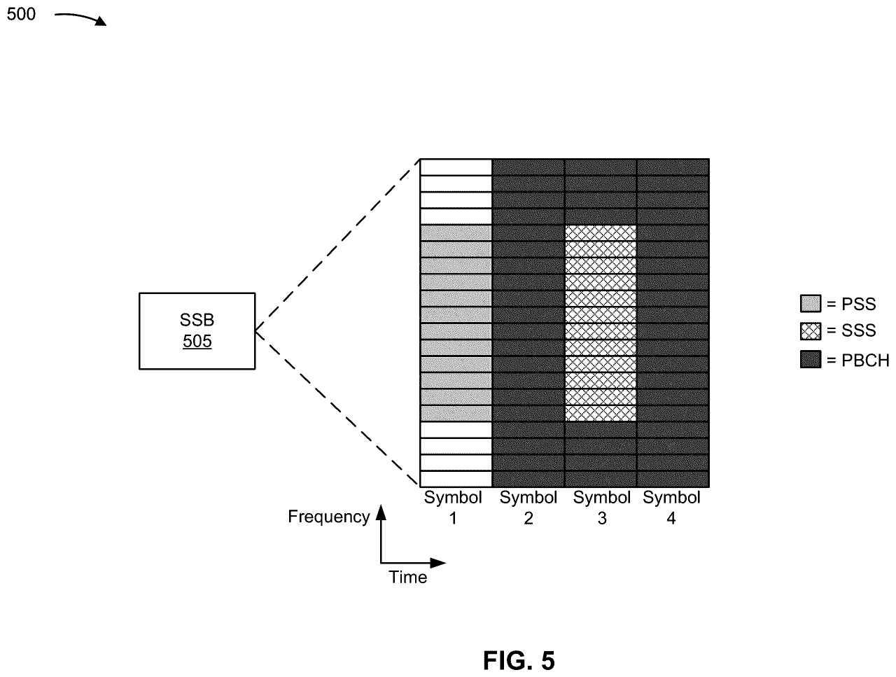

FIG. 5 is a diagram illustrating an example 500 of an SSB 505, in accordance with the present disclosure. As shown in FIG. 5, the SSB 505 may include a PSS, an SSS, and a PBCH, in a similar manner as described in connection with FIG. 4. The PSS may occupy one OFDM symbol (e.g., shown as symbol 1) of the SSB 505. The SSS may occupy one OFDM symbol (e.g., shown as symbol 2) of the SSB 505. The PBCH may occupy two or more OFDM symbols (shown as symbol 2, symbol 3, and symbol 4) of the SSB 505.

The subcarrier spacing (SCS) for the PSS and the SSS may vary based on a frequency range. For example, for sub-6 GHz frequency ranges, the SCS of the PSS and/or the SSS may be 15 kHz or 30 KHz. For frequency ranges above the sub-6 GHz frequency ranges, the SCS of the PSS and/or the SSS may be 120 kHz or 240 KHz.

The PSS, the SSS, and the PBCH may be time division multiplexed (TDM'd) in consecutive OFDM symbols of the SSB 505 (e.g., for single beam and multi-beam scenarios). The time domain mapping to the consecutive OFDM symbols may follow a pattern of PSS, PBCH, SSS+PBCH, PBCH. For example, as shown in FIG. 5, the symbol 1 may include one or more resource blocks (RBs) that carry the PSS. The symbol 2 may include one or more RBs that carry the PBCH. The symbol 3 may include one or more RBs that carry the SSS and one or more RBs that carry the PBCH. The symbol 4 may include one or more RBs that carry the PBCH. A location of the consecutive symbols (e.g., within a slot) may vary for different SCSs.

A transmission of SSBs within an SS burst may be confined to a 5 millisecond window (e.g., regardless of a periodicity of an SS burst set). Within the 5 millisecond window, there may be an allowable (e.g., a maximum) number (e.g., L) of candidate SSB locations. For example, for carrier frequency ranges up to 3 GHZ, a value of L may be 4 (e.g., there may be up to 4 candidate SSB locations within the 5 millisecond window). For carrier frequency ranges up from 3 GHz to 6 GHZ, a value of L may be 8 (e.g., there may be up to 8 candidate SSB locations within the 5 millisecond window). For carrier frequency ranges up from 6 GHz to 52.6 GHZ, a value of L may be 64 (e.g., there may be up to 64 candidate SSB locations within the 5 millisecond window).

As indicated above, FIG. 5 is provided as an example. Other examples may differ from what is described with regard to FIG. 5.

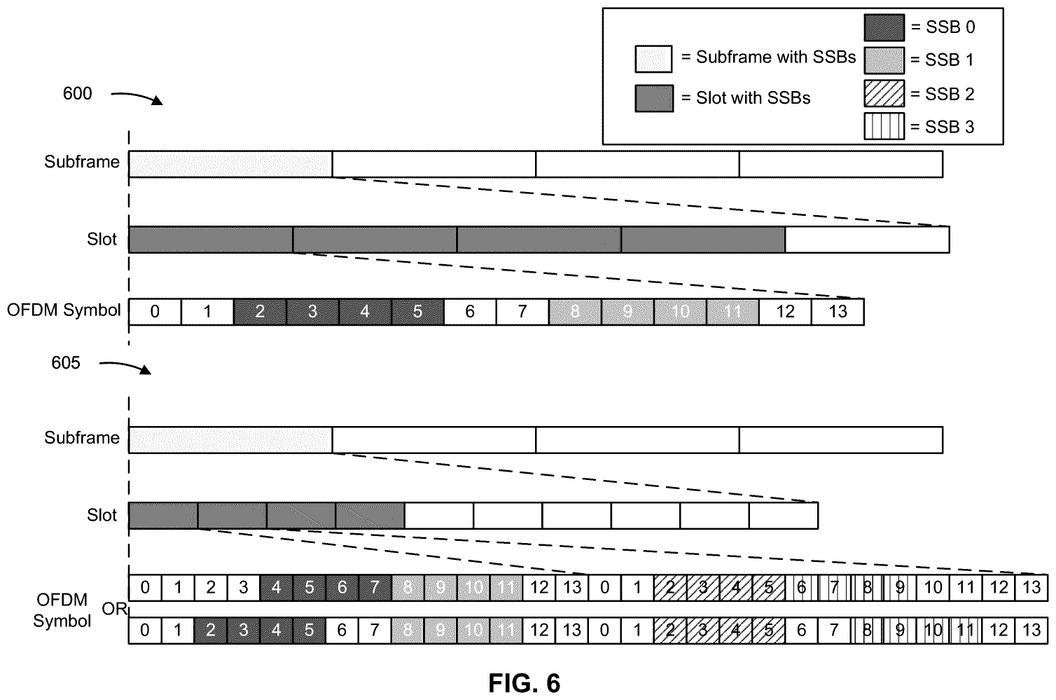

FIG. 6 is a diagram illustrating an example of candidate SSB locations, in accordance with the present disclosure. As shown in FIG. 6, a wireless communication network (e.g., the wireless communication network 100) may use a frame structure, such as a frequency division duplexing (FDD) in a telecommunication system, such as LTE or NR. The transmission timeline for each of the downlink and uplink may be partitioned into units of radio frames (sometimes referred to as frames). Each radio frame may have a predetermined duration (e.g., 10 milliseconds (ms)) and may be partitioned into a set of Z (Z≥1) subframes (e.g., with indices of 0 through Z−1). Each subframe may have a predetermined duration (e.g., 1 ms) and may include a set of slots (e.g., 2m slots per subframe, where m is an index of a numerology used for a transmission, such as 0, 1, 2, 3, 4, or another number). Each slot may include a set of S symbol periods (e.g., S OFDM symbols). For example, each slot may include fourteen symbol periods, seven symbol periods, or another number of symbol periods. In an example where a subframe includes two slots (e.g., when m=1), the subframe may include 2S symbol periods, where the 2S symbol periods in each subframe may be assigned indices of 0 through 2S−1.

For example, as shown by reference number 600, example candidate SSB locations are depicted, such as for OFDM symbols with a 15 kHz SCS. As shown in FIG. 6, a candidate location for an SSB 0 may be symbols 2 through 5 of a slot. A candidate location for an SSB 1 may be symbols 8 through 11 of the slot. As shown by reference number 605, example candidate SSB locations are depicted, such as for OFDM symbols with a 30 kHz SCS. As shown in FIG. 6, because of the higher SCS, more candidate SSB locations may be included in each subframe (e.g., there may two slots in each subframe, rather than 1 slot in each subframe in the example indicated by reference number 600). For example, a candidate location for an SSB 0 may be symbols 4 through 7 of a first slot. Alternatively, the candidate location for an SSB 0 may be symbols 2 through 5 of the first slot. A candidate location for an SSB 1 may be symbols 8 through 11 of the first slot (with or without a time gap between the candidate location for the SSB 0). A candidate location for an SSB 2 may be symbols 2 through 5 of a second slot with or without a time gap between the candidate location for an SSB 3). A candidate location for an SSB 3 may be symbols 6 through 9 of the second slot (e.g., without the time gap). Alternatively, the candidate location for an SSB 3 may be symbols 8 through 11 of the second slot (e.g., with the time gap).

Other candidate locations for SSBs when other SCSs are used may be defined or otherwise fixed, such as by a wireless communication standard (e.g., the 3GPP). For example, for OFDM symbols using a 120 kHz SCS, two consecutive slots may include up to four SSBs. For OFDM symbols using a 240 kHz SCS, two consecutive slots may include up to eight SSBs.

As indicated above, FIG. 6 is provided as an example. Other examples may differ from what is described with regard to FIG. 6.

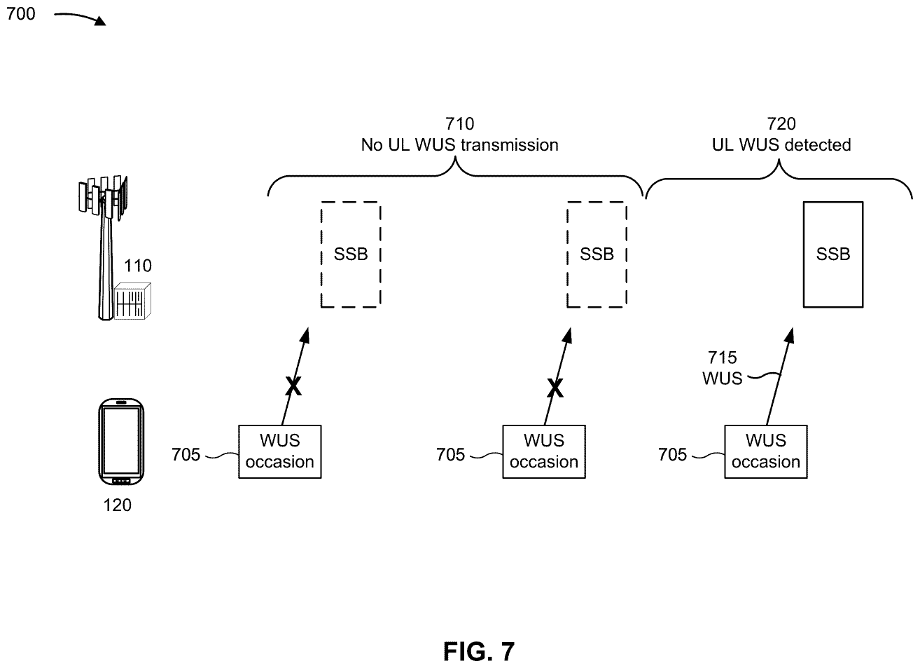

FIG. 7 is a diagram illustrating an example 700 of network energy saving, in accordance with the present disclosure.

One potential technique to increase energy efficiency in a RAN may be to enable cell discontinuous reception (DRX) or discontinuous transmission (DTX). For example, a network node 110 may transmit some broadcast communications (e.g., an SSB or a SIB, such as the SIB1) in response to detecting an uplink WUS. In some examples, the uplink WUS may be referred to as a cell WUS (C-WUS).

As shown in FIG. 7, a UE 120 be configured with periodic WUS occasions 705. A WUS occasion 705 may include radio resources available for the UE 120 to transmit an uplink WUS. In a first operation 710, if the network node 110 does not detect a WUS during a WUS occasion 705, then the network node 110 may refrain from transmitting one or more broadcast communications (shown as an SSB in FIG. 7). The UE 120 may transmit a WUS 715 to the network node 110 during a WUS occasion 705. In a second operation 720, if the network node 110 detects the WUS 715 during the WUS occasion 705, then the network node 110 may transmit one or more broadcast communications, such as an SSB. For example, the network node 110 may transmit SSBs, a SIB1 (sometimes referred to as remaining minimum system information (RMSI)), and/or serve the UE 120 for uplink data reception, among other examples. A communication (e.g., an SSB, a SIB, or another downlink communication) that is transmitted to the UE 120 based on, in response to, or otherwise associated with the reception of the WUS 715 may be referred to as an “on-demand” communication.

As indicated above, FIG. 7 is provided as an example. Other examples may differ from what is described with regard to FIG. 7.

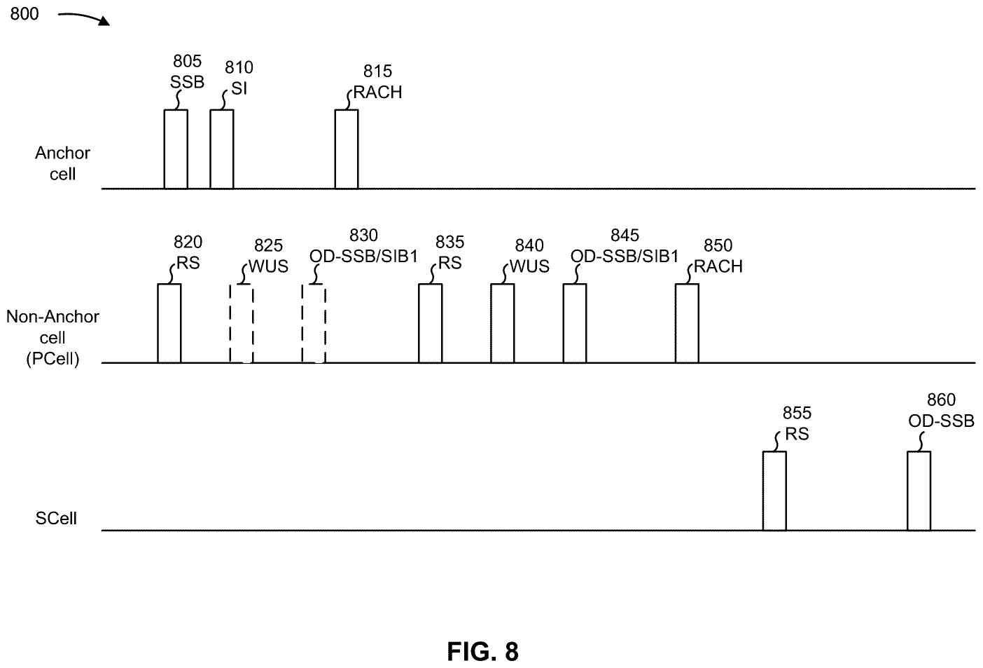

FIG. 8 is a diagram illustrating an example 800 of multi-carrier operations for on-demand communications, in accordance with the present disclosure.

As shown in FIG. 8, a UE may communicate with one or more network nodes via an anchor cell and/or one or more non-anchor cells. An “anchor cell” (or “anchor carrier”) refers to a cell that provides initial network access to a UE (e.g., in addition to providing data communication). A “non-anchor cell” (or “non-anchor carrier”) refers to a cell that does not provide initial network access, but rather only provides data communication. For example, the UE may perform a cell access procedure and/or receive system information (SI) via the anchor cell. A non-anchor cell may be configured to perform one or more energy saving operations, such as refraining from transmitting broadcast communications (e.g., SSBs, SI, and/or paging messages) unless being triggered to do so (e.g., in an on-demand manner, as described in more detail elsewhere herein).

In some examples, carrier aggregation may be configured for the UE. Carrier aggregation is a technology that enables two or more component carriers (CCs, sometimes referred to as carriers) to be combined (e.g., into a single channel) for a single UE to enhance data capacity. Carriers can be combined in the same or different frequency bands. Additionally, or alternatively, contiguous or non-contiguous carriers can be combined. A network node may configure carrier aggregation for a UE, such as in an RRC message, DCI, and/or another signaling message. In carrier aggregation, a UE may be configured with a primary carrier or primary cell (PCell) and one or more secondary carriers or secondary cells (SCells). In some examples, the PCell may carry control information (e.g., downlink control information and/or scheduling information) for scheduling data communications on one or more SCells, which may be referred to as cross-carrier scheduling. In some examples, a cell (e.g., a PCell or an SCell) may carry control information for scheduling data communications on the cell, which may be referred to as self-carrier scheduling or carrier self-scheduling.

For example, the UE may be operating in an RRC idle mode or an RRC inactive mode without the SCell shown in FIG. 8 being configured. In some examples, the non-anchor cell may be configured as a PCell (e.g., without carrier aggregation being configured). As shown in FIG. 8, the UE may receive one or more SSBs 805 via the anchor cell. Additionally, the UE may receive SI 810 via the anchor cell. The SI 810 may include minimum system information (MSI) (e.g., a master information block (MIB) and/or an SSB), RMSI (e.g., a SIB1), and/or other SI (OSI), among other examples. In some examples, the SI 810 may include a WUS configuration (e.g., indicating one or more time/frequency occasions available for the UE to transmit a C-WUS). In some examples, the SI 810 may include SI for the non-anchor cell. As shown by reference number 815, the UE may perform a RACH procedure to establish a connection with the anchor cell.

As shown in FIG. 8, the UE may receive a reference signal (RS) 820 via the non-anchor cell. The RS 820 may be a reference signal associated with providing time domain tracking, frequency domain tracking, and/or pathloss measurements for WUS transmissions by the UE. In some examples, the RS may be referred to as a different name (e.g., a different type of reference signal), such as a DRS. For example, for UEs operating in an RRC idle mode or an RRC inactive mode, time domain tracking information, frequency domain tracking information, and/or pathloss information, among other examples, may be unavailable for transmissions to a non-anchor cell. Therefore, the RS 820 may be used to provide such information to the UE. The UE may be configured (e.g., via the SI 810) with a WUS occasion 825. However, based on a measurement of the RS 820, the UE may determine to not transmit a C-WUS via the WUS occasion 825 (e.g., as indicated by the dashed lines in FIG. 8). Therefore, the non-anchor cell (e.g., a network node supporting the non-anchor cell) may refrain from transmitting an on-demand broadcast communication 830 (e.g., an SSB or SIB1). For example, the non-anchor cell, based on not receiving or detecting a C-WUS, may remain in a sleep state or non-active state to conserve energy and/or power.

The UE may receive an RS 835 via the non-anchor cell. In a similar manner as described above, the UE may be configured with a WUS occasion 840. Based on a measurement of the RS 835, the UE may transmit a C-WUS via the WUS occasion 840. Based on receiving the C-WUS, the non-anchor cell may transmit an on-demand broadcast communication 845 (e.g., an SSB or SIB1). Based on receiving the on-demand broadcast communication 845, the UE may perform a RACH procedure 850 via the non-anchor cell (e.g., to establish a communication connection with the non-anchor cell). For example, the UE may transition to an RRC connected mode based on performing the RACH procedure 850. In some examples, the SCell depicted in FIG. 8 may be configured for the UE based on performing the RACH procedure 850 (e.g., based on establishing the communication connection with the non-anchor cell or PCell).

In some examples, such as for SCells or in carrier aggregation scenarios, on-demand broadcast communications may be transmitted based on, or in response to, network coordination (e.g., rather than in response to a UE trigger, such as a C-WUS transmission). For example, the UE may receive an RS 855 via the SCell. The UE may measure the RS 855. The UE may transmit, to the non-anchor cell (e.g., the PCell) or the anchor cell, a measurement report indicating the measurement of the RS 855. The UE may indicate RS measurements of other SCells via the measurement report (or via other measurement reports). A network node (e.g., that supports the PCell or the anchor cell) may determine one or more SCells via which an on-demand broadcast communication 860 is to be transmitted for the UE. For example, the network node may evaluate the RS measurements and determine one or more best SCells for the UE. For example, the UE may receive an on-demand SSB 860 via the SCell based on the network node determining that the SCell is to transmit the on-demand SSB 860 and/or based on the network node causing the SCell to transmit the on-demand SSB 860.

As described elsewhere herein, the UE may need time domain tracking information, frequency domain tracking information, and/or pathloss information, among other examples, for broadcast communications (e.g., SSBs or SI) that are transmitted in response to a trigger (e.g., on-demand broadcast communications), such as a C-WUS communication or a network trigger, among other examples. However, for UEs operating in an RRC idle mode or an RRC inactive mode, the UE may not have access to such information for non-anchor cells. Additionally, for UEs configured with a carrier aggregation configuration, the UE may not have access to such information for SCells. In some examples, the non-anchor cells or SCells may transmit a reference signal to provide domain tracking information, frequency domain tracking information, and/or pathloss information, among other examples, for the on-demand broadcast communications. However, a timing and/or content of the reference signals is not defined. Additionally, using known reference signals, such as an SSB, for this purpose may consume significant energy and/or power resources of the cells, thereby negating any benefits of the energy saving operations (e.g., the on-demand broadcast transmission operations) performed by the cells.

As indicated above, FIG. 8 is provided as an example. Other examples may differ from what is described with regard to FIG. 8.

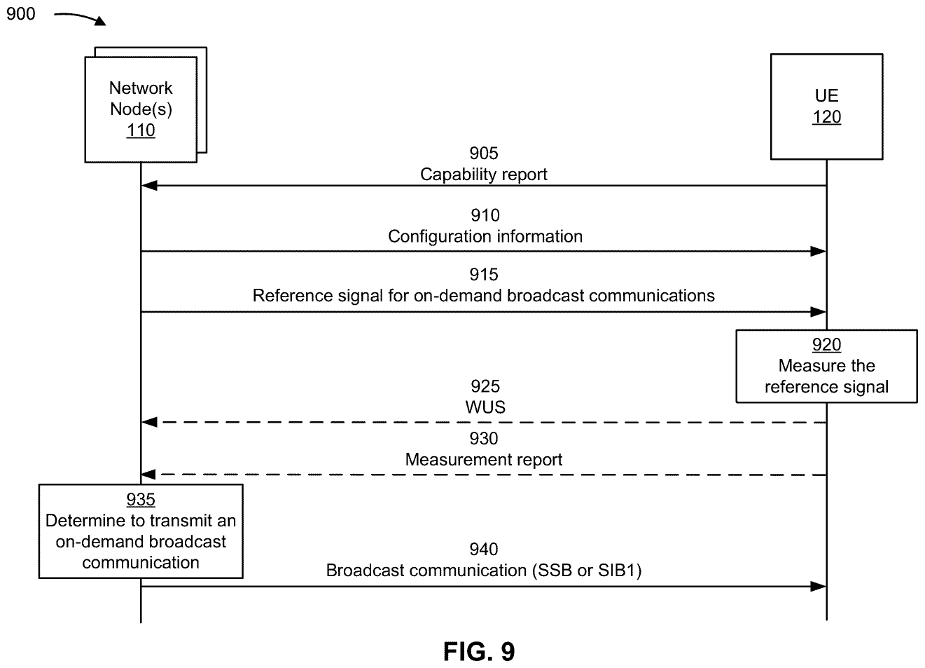

FIG. 9 is a diagram of an example 900 associated with a reference signal for on-demand broadcast communications, in accordance with the present disclosure. As shown in FIG. 9, one or more network nodes 110 (e.g., a base station, a CU, a DU, and/or an RU) may communicate with a UE 120. In some aspects, the network node(s) 110 and the UE 120 may be part of a wireless network (e.g., the wireless communication network 100). The UE 120 and the network node 110 may have established a wireless connection prior to operations shown in FIG. 9.

In some aspects, the one or more network nodes 110 may be associated with an anchor cell and one or more non-anchor cells of the UE 120. For example, the one or more network nodes 110 may support an anchor cell. In some aspects, the one or more network nodes 110 may support one or more non-anchor cells. In some aspects, the one or more network nodes 110 may support a PCell and/or one or more SCells configured for the UE 120.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU).

As used herein, a network node 110 “outputting” or “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU outputting or transmitting a communication to an RU and the RU transmitting the communication to the UE 120, or may include causing the RU to transmit the communication (e.g., triggering transmission of a physical layer reference signal). Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU. Similarly, the network node 110 “obtaining” a communication may refer to receiving a transmission carrying the communication directly (for example, from the UE 120 to the network node 110) or receiving the communication (or information derived from reception of the communication) via one or more other network nodes or devices.

In some aspects, as shown by reference number 905, the UE 120 may transmit, and the network node 110 may receive, a capability report. The UE 120 may transmit the capability report via an uplink communication, a UE assistance information (UAI) communication, an uplink control information (UCI) communication, an uplink MAC control element (MAC-CE) communication, an RRC communication, a physical uplink control channel (PUCCH), and/or a physical uplink shared channel (PUSCH), among other examples. The capability report may indicate one or more parameters associated with respective capabilities of the UE 120. The one or more parameters may be indicated via respective information elements (IEs) included in the capability report.

The capability report may indicate whether the UE 120 supports a feature and/or one or more parameters related to the feature. For example, the capability report may indicate a capability and/or parameter for the reference signal described herein (e.g., the reference signal associated with on-demand broadcast communications, such as SSBs or SIBs). In some aspects, the reference signal may be referred to as a simplified SSB, a reduced SSB, and/or a DRS, among other examples. As another example, the capability report may indicate a capability and/or parameter for supported content and/or timing of the reference signal. One or more operations described herein may be based on capability information of the capabilities report. For example, the UE may perform a communication in accordance with the capability information, or may receive configuration information that is in accordance with the capability information. In some aspects, the capability report may indicate UE support for a TSS, one or more supported SCSs for the reference signal, and/or one or more supported transmission patterns for the reference signal, among other examples.

As shown by reference number 910, the network node 110 may transmit, and the UE 120 may receive, configuration information. In some aspects, the UE 120 may receive the configuration information via one or more of system information (e.g., a MIB and/or a SIB, among other examples), RRC signaling, one or more MAC control elements (MAC-CEs), and/or DCI, among other examples. The configuration information may be transmitted via an anchor cell of the UE 120.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE 120 is to receive one or more reference signals for broadcast communications that are transmitted based on, in response to, or otherwise associated with a trigger (e.g., on-demand broadcast communications). In some aspects, the configuration information may indicate that the reference signal is to be transmitted via a non-anchor cell, a PCell, or an SCell.

In some aspects, the configuration information may include an SSB configuration for SSBs that carry first synchronization information. The SSB configuration may indicate information for an SSB measurement window timing and/or frequency. Additionally, or alternatively, the SSB configuration may indicate an SCS of the SSBs. The SSB configuration may be indicated by a serving cell configuration, such as a ServingCellConfigCommon RRC IE. In some aspects, a transmission pattern for an SSB may be indicated by an RRC IE, such as an ssb-PositionsInBurst RRC IE.

The first synchronization information may include a PSS, an SSS, and a PBCH, in a similar manner as described in connection with FIG. 4. For example, in a wireless network, such as an NR network, a network node periodically broadcasts or otherwise transmits an SSB over an access link (e.g., a Uu interface) to enable initial network acquisition and synchronization for UEs. Additionally, or alternatively, the SSB may be used for cell search on an access link, beam management on an access link, and/or beam selection on an access link, among other examples. For example, an SSB includes a PSS, an SSS, and a PBCH carrying information that a UE may use to derive, decode, or otherwise obtain information to access a cell provided by the network node (e.g., a radio frame boundary, a physical cell identity, and/or a MIB that provides parameters to acquire SIB1, among other examples). Furthermore, in some aspects, the PBCH often includes a DMRS that carries a sequence or other suitable information to enable a UE to perform channel estimation to demodulate or decode the PBCH.

For F example, an SSB transmitted on an access link typically occupies four (4) consecutive symbols in a time domain and includes a PSS, an SSS, and a PBCH spread over 240 subcarriers in a frequency domain (e.g., 20 RBs that each include 12 subcarriers). The PSS typically occupies a first symbol and spans 127 subcarriers, and the SSS is located in the third symbol and spans 127 subcarriers, with 8 unused subcarriers above the SSS and 9 unused subcarriers below the SSS. Furthermore, the PBCH typically occupies two full symbols, spanning 240 subcarriers (or 20 RBs) in the second symbol and 240 subcarriers (or 20 RBs) the fourth symbol, and the PBCH partially occupies the third symbol, spanning 48 subcarriers (or 4 RBs) above the SSS and 48 subcarriers (or 4 RBs) below the SSS, whereby the PBCH occupies 576 subcarriers across three symbols. Furthermore, the PBCH DMRS occupies three (3) REs in each RB allocated to the PBCH, whereby the PBCH DMRS occupies 144 REs across three symbols (e.g., 3 REs in each of 48 RBs allocated to the PBCH) and the remaining 432 REs in the 48 RBs allocated to the PBCH carry the PBCH payload. In some aspects, the TSS described herein may be, or may include, the PBCH DMRS.

In some aspects, one or more candidate SSB locations may be defined or otherwise fixed (e.g., by a wireless communication standard, such as the 3GPP), in a similar manner as described in connection with FIG. 6. For example, the SSB locations may not be indicated by the SSB configuration. The UE 120 may search for SSBs in time and/or frequency locations to determine the SSB location(s) used for a given SSB.

In some aspects, the configuration information may include a WUS configuration. For example, the configuration information may indicate one or more WUS occasions (e.g., time/frequency occasions) available for the UE 120 to transmit a C-WUS.

In some aspects, the configuration information may indicate information for the RS (e.g., the simplified SSB, the reduced SSB, or the DRS). For example, the configuration information may indicate an SCS for the RS. In some aspects, the UE 120 may determine one or more parameters of the reference signal based on the SSB configuration. For example, the reference signal may use the same SCS as indicated by the SSB configuration.

In some aspects, the configuration information may configure one or more measurement windows. For example, the configuration information may configure an SSB measurement window. Additionally, or alternatively, the configuration window may configure a measurement window for the reference signals (e.g., simplified SSBs, reduced SSB, or DRSs). In some aspects, a timing of the SSB measurement window (e.g., for measuring on-demand SSBs) may be relative to a timing of the measurement window for the reference signals, as described in more detail elsewhere herein.

The UE 120 may configure itself based at least in part on the configuration information. In some aspects, the UE 120 may be configured to perform one or more operations described herein based at least in part on the configuration information.

In some aspects, the configuration information described in connection with reference number 910 and/or the capability report may include information transmitted via multiple communications. Additionally, or alternatively, the network node 110 may transmit the configuration information, or a communication including at least a portion of the configuration information, before and/or after the UE 120 transmits the capability report. For example, the network node 110 may transmit a first portion of the configuration information before the capability report, the UE 120 may transmit at least a portion of the capability report, and the network node 110 may transmit a second portion of the configuration information after receiving the capability report.

As shown by reference number 915, the network node 110 may transmit, and the UE 120 may receive, a reference signal (e.g., a reduced SSB, a simplified SSB, and/or a DRS). The reference signal may be for on-demand broadcast communications, such as an SSB or SIB (e.g., SIB1), among other examples. For example, the reference signal may be associated with providing time domain tracking information, frequency domain tracking information, and/or pathloss information, among other examples, for on-demand broadcast communications, such as SSBs or SIBs (e.g., SIB1). The reference signal may be a DRS or another type of reference signal.

The reference signal may include reduced synchronization information. For example, an SSB may include first synchronization information (e.g., a PSS, an SSS, and a PBCH). The reference signal may include second synchronization information that is reduced relative to the first synchronization information. For example, the reference signal may include only a PSS and an SSS (e.g., and not the PBCH). In some aspects, the reference signal may include only a PSS, an SSS, and a TSS (e.g., and not the PBCH). The TSS may be a sequence associated with indicating an index of the reference signal, among other examples. In some aspects, the TSS may be, or may include, a DMRS of a PBCH. In some aspects, the TSS may indicate beam information for the reference signal. In some aspects, the reference signal may indicate (or the UE 120 may obtain via the reference signal) symbol timing information and/or a PCI of a cell via which the reference signal is transmitted.

In some aspects, reference signal may indicate (or the UE 120 may obtain via the reference signal) symbol timing information, slot timing information, the PCI, and/or beam information. For example, the TSS may indicate the index of the reference signal. The UE 120 may determine spatial domain information (e.g., a downlink beam) used to transmit the reference signal. The UE 120 may determine an uplink beam (e.g., corresponding to the downlink beam) based on the spatial domain information. The UE 120 may associate the uplink beam with the cell via which the reference signal is transmitted (e.g., using the index of the reference signal).

As described elsewhere herein, an SSB may be associated with an SSB location in a time domain and a first transmission pattern. The network node 110 may transmit, and the UE 120 may receive, the reference signal in at least a portion of the SSB location and using a second transmission pattern. For example, the SSB location may include a first time domain location for a PSS, a second time domain location for an SSS, and a third time domain location for a PBCH. For example, the SSB location may include four OFDM symbols. The PSS may be included in the first OFDM symbol. The SSS may be included in the third OFDM symbol. The PBCH may be included in the second OFDM symbol, the third OFDM symbol, and the fourth OFDM symbol. In some aspects, the second transmission pattern includes the PSS in the first time domain location and the SSS in a fourth time domain location. For example, the PSS may be included in the first OFDM symbol and the SSS may be included in the second OFDM symbol. In other words, the reference signal may include the PSS and the SSS remapped to the second OFDM symbol. The SSB location may include a second reference signal (e.g., with a PSS in the third OFDM symbol and an SSS in the fourth OFDM symbol). For example, the UE 120 may expect the reference signal in the SSB location (e.g., as described herein) and may not expect the reference signal in other symbols, slots, or subframes (e.g., in which an SSB is not expected).

In some aspects, the second transmission pattern may include only the PSS in the first time domain location and the SSS in the second time domain location. For example, the PSS may be included in the first OFDM symbol and the SSS may be included in the third OFDM symbol (e.g., where the second OFDM symbol and the fourth OFDM symbol are unoccupied).

In some aspects, the second transmission pattern may include the PSS in the first time domain location, the SSS in a fourth time domain location, and a TSS in at least one of the first time domain location or the fourth time domain location. For example, the PSS may be included in the first OFDM symbol and the SSS may be included in the second OFDM symbol. The TSS may be included in the first OFDM symbol and/or the second OFDM symbol. The PSS and the SSS may be included in first one or more frequency domain resources of the reference signal and the TSS may be included in second or more frequency domain resources of the reference signal. For example, the TSS may be frequency division multiplexed with the PSS and/or the SSS. In other examples, the TSS may be time division multiplexed with the PSS and/or the SSS (e.g., and the PSS, the SSS, and the TSS may be included in separate OFDM symbols). The TSS may be, or may include, a PBCH DMRS. For example, the PBCH DMRS (e.g., of a typical SSB) may be remapped into time resources and/or frequency resources associated with the TSS, as described herein.

As shown by reference number 920, the UE 120 may measure the reference signal. For example, the UE 120 may search for the reference signal in the expected time and/or frequency domain locations (e.g., as described elsewhere herein). The UE 120 may detect the reference signal based on searching for the reference signal. The UE 120 may perform one or more measurements of the reference signal to obtain measurement information. In some aspects, the measurement information may indicate one or more RSRP values or another measurement value. Additionally, the measurement information may indicate timing information, such as symbol timing information or slot timing information. For example, if the reference signal indicates an index (e.g., indicated via TSS), then the UE 120 may use the index to determine an expected location in a slot for that index. From the expected location in the slot, the UE 120 may use the timing of the reference signal to determine a slot timing for the cell.

Additionally, the measurement information may indicate frequency information. For example, the UE 120 may determine a frequency via which the reference signal is received. Additionally, the measurement information may indicate beam information. For example, the UE 120 may determine spatial domain information for the reference signal (e.g., a downlink beam via which the reference signal is transmitted).

The UE 120 may measure one or more reference signals in a similar manner as described herein. For example, the UE 120 may measure reference signals from respective cells (e.g., from multiple cells). The UE 120 may obtain measurement information for each cell.

The UE 120 may transmit, and the network node 110 may receive, a communication in association with the measurement information. For example, as shown by reference number 925, the UE 120 may transmit a C-WUS. The C-WUS may be a PRACH communication or a scheduling request, among other examples. For example, the UE 120 may determine, using the measurement information, a cell to wake up. For example, the UE 120 may use the measurement information from multiple cells to determine a cell associated with a highest signal strength or a best signal quality (e.g., based on the measurement of the reference signals, such as DRSs). The UE 120 may transmit the C-WUS to the cell. For example, the UE 120 may obtain the PCI of the cell via the reference signal. Additionally, the UE 120 may obtain timing information and/or frequency information for the cell. For example, the UE 120 may determine, based on the measurement of the reference signal, a symbol timing and/or a slot timing for the cell. Additionally, the UE 120 may obtain spatial domain information for the cell. For example, the UE 120 may determine an uplink beam to be used to transmit the C-WUS based on the downlink beam used to transmit the reference signal. For example, the uplink beam may be in a same corresponding spatial direction as the downlink beam. The UE 120 may transmit the C-WUS using the timing information, the frequency information, and/or the spatial information (e.g., beam information) obtained via the reference signal.

The UE 120 may transmit the C-WUS to trigger a transmission of a broadcast communication, such as an SSB or a SIB (e.g., the SIB1). For example, the UE 120 may determine that a communication connection is to be established with the cell (e.g., because the UE 120 may be operating in an RRC idle state or an RRC inactive state). However, because the cell may be in an energy saving mode and/or may not be transmitting SSBs or the SIB1, the UE 120 may transmit the C-WUS to trigger the cell to transmit the SSB or the SIB1 (e.g., to enable the UE 120 to obtain information to be used to access the cell or establish a communication connection via the cell).

Additionally, or alternatively, as shown by reference number 930, the UE 120 may transmit, and the network node 110 may receive, a measurement report. The measurement report may indicate the measurement information for the reference signal. In some aspects, the measurement report may indicate measurement information for multiple reference signals (e.g., for respective cells). Alternatively, the UE 120 may transmit multiple measurement reports for respective cells indicating measurement information of a reference signal (e.g., a reduced SSB, a simplified SSB, or a DRS).

As shown by reference number 935, the network node 110 may determine to transmit an on-demand broadcast communication (e.g., SSB or SIB1). In some aspects, such as when the UE 120 is in an RRC idle mode or an RRC inactive mode and/or when carrier aggregation is not configured for the UE 120, the network node 110 may determine to transmit the on-demand broadcast communication based on, in response to, or otherwise associated with receiving the C-WUS (e.g., transmitted as described in connection with reference number 925). For example, the network node 110 may determine to transition a cell from a sleep state to an active state based on, in response to, or otherwise associated with receiving the C-WUS indicating the PCI of the cell.

Additionally, or alternatively, the network node 110 may determine to transmit an on-demand broadcast communication based on the measurement information. For example, if carrier aggregation is configured for the UE 120, the measurement information may indicate measurements of reference signals from one or more SCells. The network node 110 may use the measurement information to determine a best one or more SCells to be configured for the UE 120. The network node 110 may cause or trigger a broadcast communication (e.g., an SSB or the SIB1) to be transmitted via the one or more SCells (e.g., to enable the UE 120 to establish a communication connection with the one or more SCells).

As shown by reference number 940, the network node 110 may transmit, and the UE 120 may receive, a broadcast communication (e.g., an SSB or SIB, such as SIB1). For example, the network node 110 may transmit, and the UE 120 may receive, the broadcast communication based on, in response to, or otherwise associated with a trigger. The trigger may be a UE trigger, such as the transmission of the C-WUS. Alternatively, the trigger may be a network trigger, such as the network node 110 determining that the broadcast communication is to be transmitted using measurement information of the reference signal. In other words, the broadcast communication may be an on-demand broadcast communication (e.g., an on-demand SSB or an on-demand SIB). The UE 120 may use the content of the broadcast communication to perform a RACH procedure and establish a communication connection with the cell.

As indicated above, FIG. 9 is provided as an example. Other examples may differ from what is described with respect to FIG. 9.

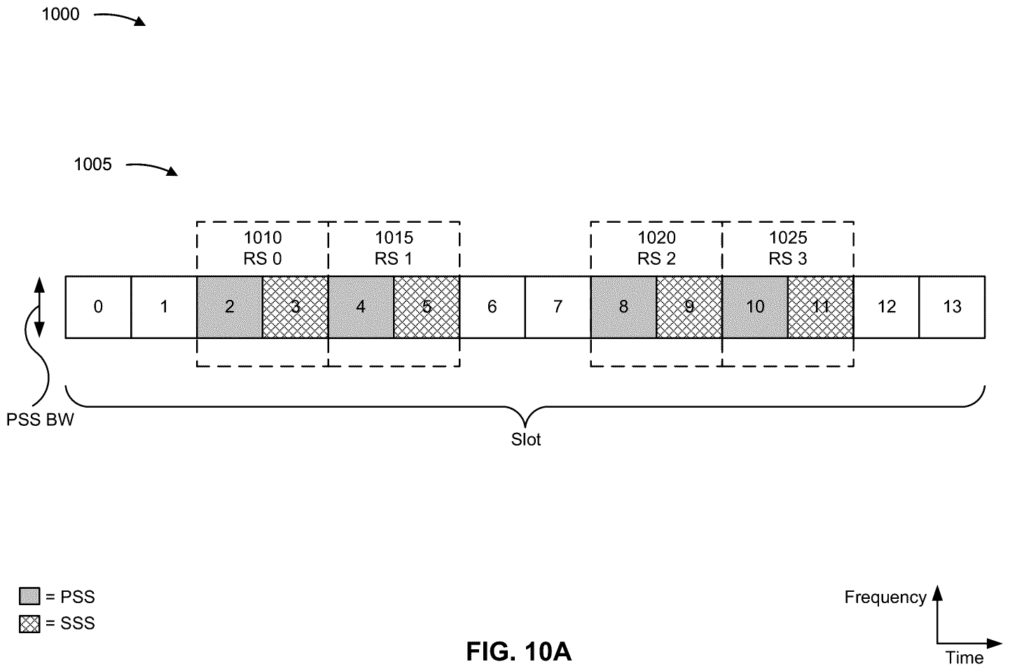

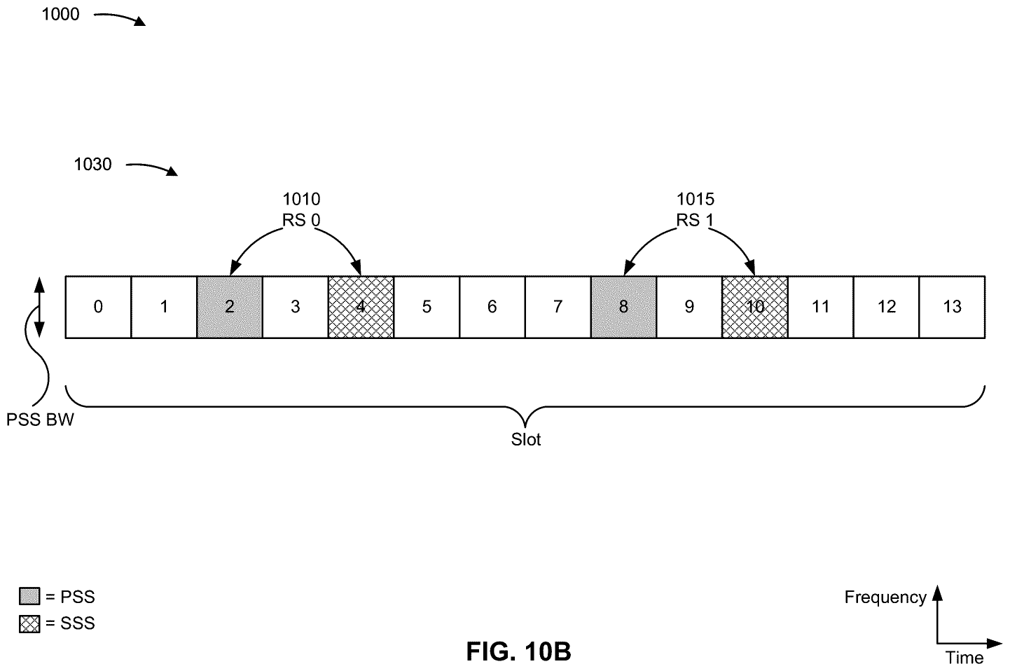

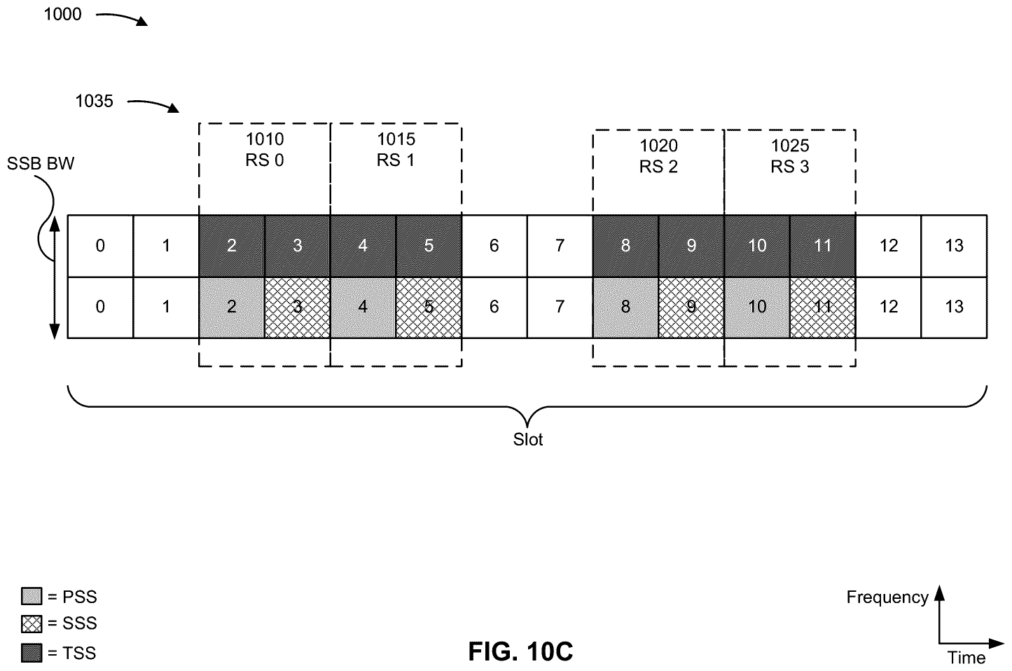

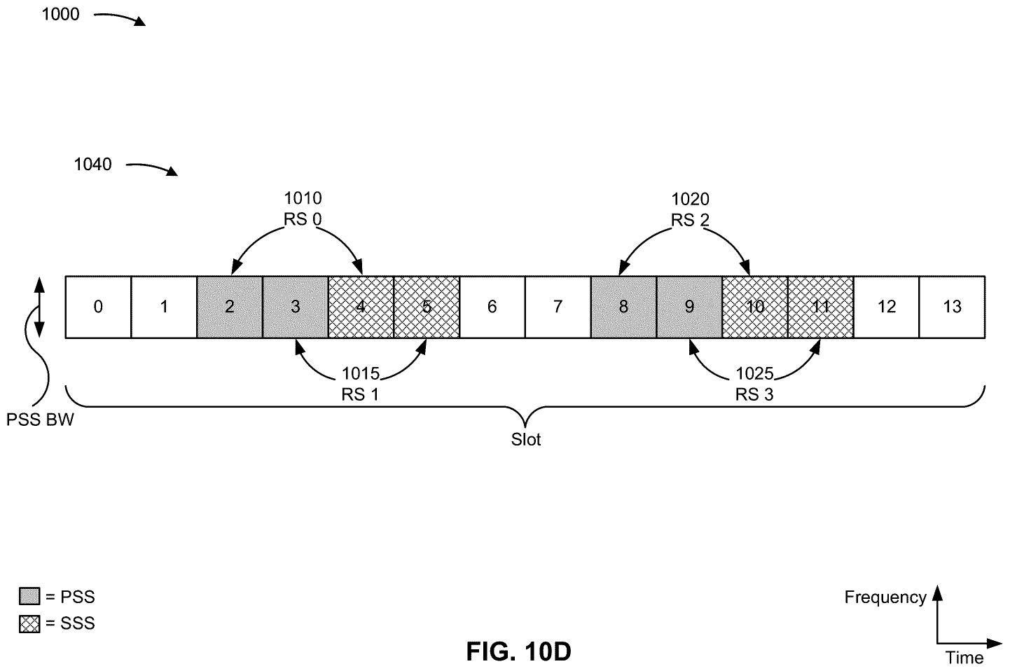

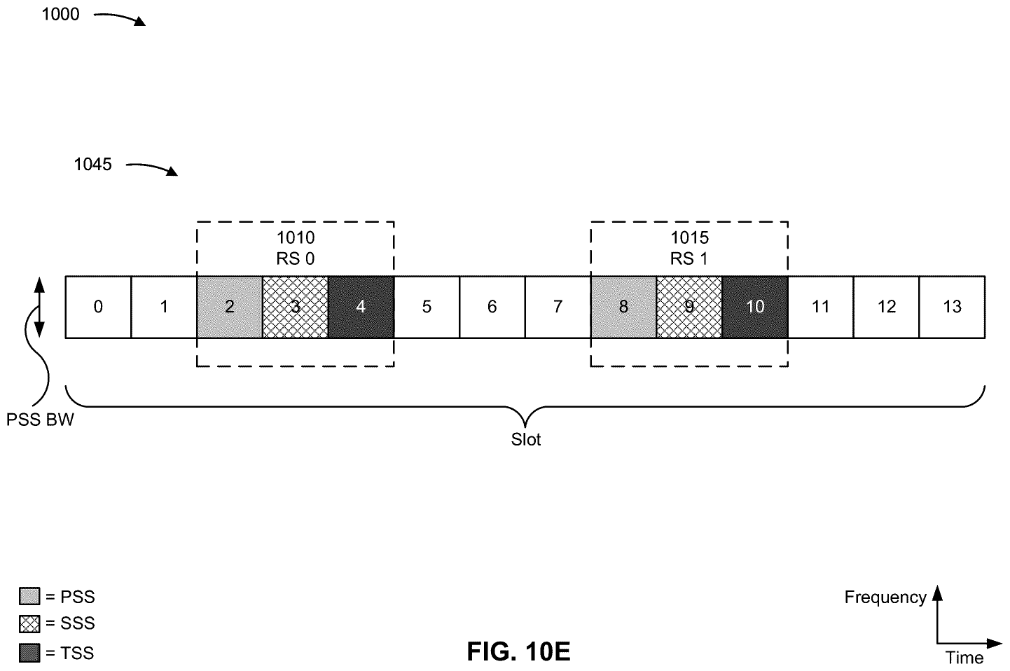

FIGS. 10A-10E are diagrams of example formats of a reference signal for on-demand broadcast communications, in accordance with the present disclosure. The formats described and depicted herein are provided as examples. Other examples, such as for other SSB locations or formats, may differ from what is depicted and/or described herein.

As shown in FIG. 10A, a first format 1005 may include four reference signals in a slot (shown as RS 0 1010, RS 1 1015, RS 2 1015, and RS 3 1025). The reference signals may be included in SSB locations (e.g., time domain locations that would otherwise be associated with an SSB). For example, the SSB locations in the slot shown in FIG. 10A may be in symbols 2 through 5 and symbols 8 through 11. As shown in FIG. 10A, the RS 0 1010 may be included in the symbols 2 and 3. For example, a PSS may be included in the symbol 2 and an SSS may be included in the symbol 3. The RS 1 1015 may be included in the symbols 4 and 5. For example, a PSS may be included in the symbol 4 and an SSS may be included in the symbol 5. In other words, a first portion of the SSB location includes a first reference signal (e.g., the RS 0 1010) and a second portion of the SSB location includes a second reference signal (e.g., the RS 1 1015). The RS 2 1020 may be included in the symbols 8 and 9. For example, a PSS may be included in the symbol 8 and an SSS may be included in the symbol 9. The RS 3 1025 may be included in the symbols 10 and 11. For example, a PSS may be included in the symbol 10 and an SSS may be included in the symbol 11.

As shown in FIG. 10A, the reference signals may be included in a bandwidth of a PSS of the SSB. For example, if the PSS of the SSB spans 127 subcarriers, then the bandwidth of the reference signals (e.g., RS 0 1010, RS 1 1015, RS 2 1015, and RS 3 1025) may be 127 subcarriers. As shown in FIG. 10A, a UE 120 may not expect the reference signals in symbols not associated with an SSB location, such as the symbols 0, 1, 6, 7, 12, and 13. The first format 1005 may enable a network node to transmit four reference signals via two SSB locations in a given slot. Therefore, in another slot, the network node may enter a sleep state to conserve power (e.g., rather than transmitting during the SSB locations in that slot).

As shown in FIG. 10B, a second format 1030 may include two reference signals in a slot (shown as RS 0 1010 and RS 1 1015). The reference signals in FIG. 10B may include only the PSS and the SSS (e.g., and not the PBCH or the TSS). The parts of the reference signals may be included in the same time domain and/or frequency domain as otherwise would be the case for an SSB. For example, an SSB location in the slot may include the PSS in the symbol 2 and an SSS in the symbol 4. Rather than including the PBCH in the symbol 3 and the symbol 5 (e.g., as would be the case for an SSB), the RS 0 1010 may only be transmitted in the symbol 2 and the symbol 4 (e.g., symbol 3 and symbol 4 may be unoccupied). Similarly, the RS 1 1015 may be included in the symbol 8 (e.g., a PSS may be included in the symbol 8) and the symbol 10 (e.g., an SSS may be included in the symbol 10). The symbol 9 and the symbol 11 may be unoccupied (e.g., the UE 120 may not expect a reference signal in the symbol 9 or in the symbol 11). For example, the network node may transmit the PSS and the SSS in a similar manner (e.g., the same mapping or transmission pattern) as an SSB, but may refrain from transmitting the PBCH.

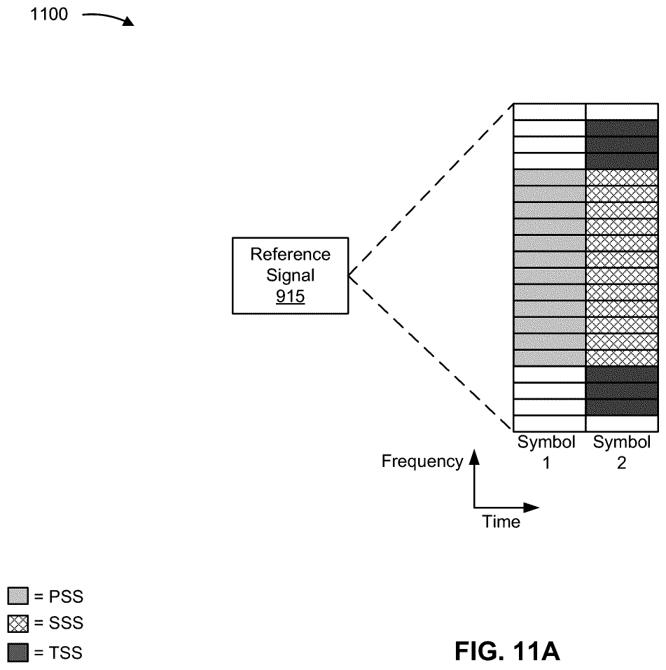

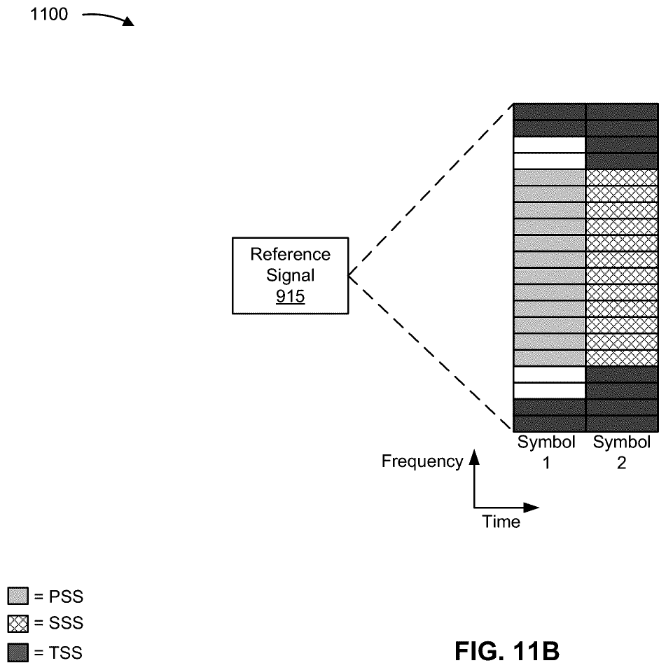

FIG. 10C depicts a third format 1035 that includes reference signals having a TSS. The third format 1035 may be similar to the first format 1005, but may span a bandwidth of the SSB (e.g., rather than only the bandwidth of the PSS) to include the TSS frequency division multiplexed with the PSS and/or the SSS (e.g., as depicted in FIGS. 11A and 11B).

FIG. 10D depicts a fourth format 1040 that includes four reference signals in a slot (shown as RS 0 1010, RS 1 1015, RS 2 1015, and RS 3 1025). As shown in FIG. 10D, the fourth format 1040 may include a first portion of an SSB location including PSSs for a first reference signal (e.g., the RS 0 1010) and a second reference signal (e.g., the RS 1 1015) and a second portion of the SSB location including SSSs for the first reference signal and the second reference signal. For example, the symbol 2 may include a PSS for the RS 0 1010 and the symbol 4 may include the SSS for the RS 0 1010. The symbol 3 may include a PSS for the RS 1 1015 and the symbol 5 may include the SSS for the RS 1 1015. Similarly, the symbol 8 may include a PSS for the RS 2 1020 and the symbol 10 may include the SSS for the RS 2 1020. The symbol 9 may include a PSS for the RS 3 1025 and the symbol 11 may include the SSS for the RS 3 1025.

FIG. 10E depicts a fifth format 1045 that includes two reference signals in a slot (shown as RS 0 1010 and RS 1 1015). The reference signals may include TSSs. For example, the fifth format 1045 may be associated with a reference signal including a TSS that is time division multiplexed with the PSS and the SSS. For example, the RS 0 1010 may include a PSS in the symbol 2, an SSS in the symbol 3, and a TSS in the symbol 4. As another example, the RS 1 1015 may include a PSS in the symbol 8, an SSS in the symbol 9, and a TSS in the symbol 10. In some aspects, another reference signal may be included in the symbols 5 through 7 in a similar manner.

As indicated above, FIGS. 10A-10E are provided as examples. Other examples may differ from what is described with respect to FIGS. 10A-10E.

FIGS. 11A-11B are diagrams of example 1100 of formats of a reference signal for on-demand broadcast communications, in accordance with the present disclosure. FIGS. 11A and 11B show example formats of an RS, such as the reference signal transmitted as described in connection with FIG. 9 and reference number 915. As shown in FIGS. 11A and 11B, the reference signal may span two symbols (e.g., two OFDM symbols) and may include a PSS, an SSS, and a TSS.

As shown in FIG. 11A, the reference signal may include the PSS in a first symbol. The PSS may span a subset of the bandwidth of the reference signal (e.g., which may be the bandwidth of an SSB). For example, the bandwidth of the reference signal may spread over 240 subcarriers in the frequency domain (e.g., 20 RBs that each include 12 subcarriers). The PSS may occupy a first symbol and spans 127 subcarriers (e.g., 12 RBs), and the SSS may be located in the second symbol and spans 127 subcarriers, with 8 unused subcarriers above the SSS and 9 unused subcarriers below the SSS. The TSS may occupy 6 RBs in the second symbol (e.g., three RBs above the SSS in the frequency domain and three RBs below the SSS in the frequency domain). The example depicted in FIG. 11A may be for a TSS having a 63-length binary phase-shift keying (BPSK) modulated sequence (m-sequence). TSSs having different sequence lengths may result in different formats and/or may occupy more or fewer RBs.

FIG. 11B depicts an example in which the TSS is included in both the first symbol and the second symbol. For example, the TSS may occupy 12 RBs. The TSS may occupy four RBs in the first symbol (e.g., with two unoccupied RBs above and below the PSS). The TSS may occupy eight RBs in the second symbol (e.g., four RBs above the SSS and four RBs below the SSS). The example depicted in FIG. 11B may be for a TSS having a 127-length m-sequence.

As indicated above, FIGS. 11A-11B are provided as examples. Other examples may differ from what is described with respect to FIGS. 11A-11B.

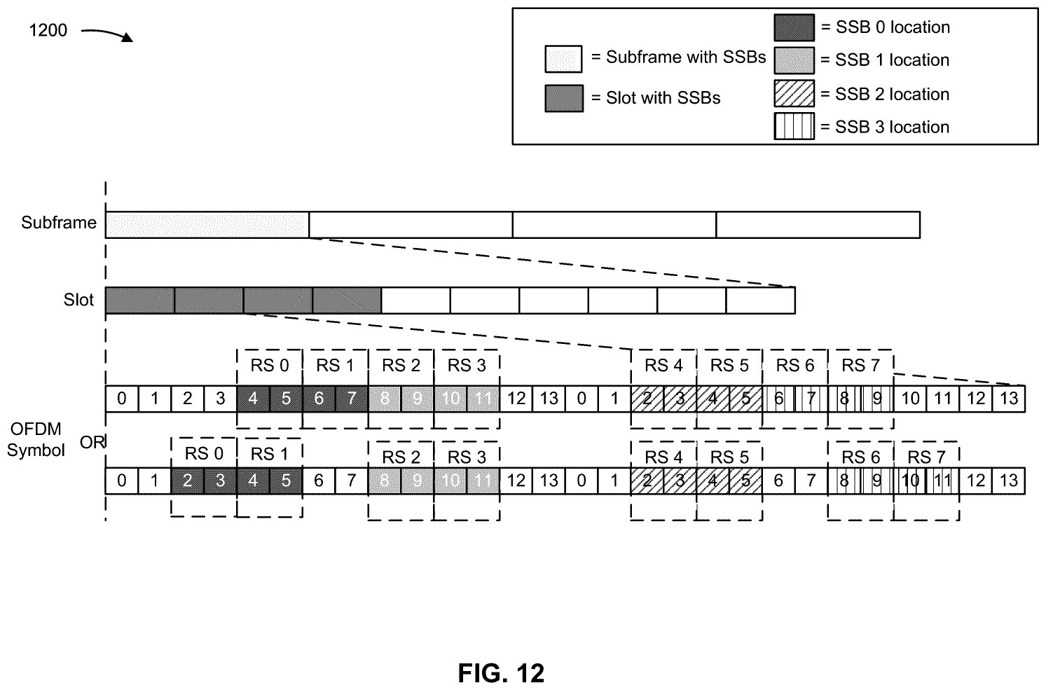

FIG. 12 is a diagram of an example 1200 associated with reference signal locations for on-demand broadcast communications, in accordance with the present disclosure. FIG. 12 depicts the locations of the reference signals in the context of candidate SSB locations. For example, as described elsewhere herein, the reference signals may be included in (e.g., may reuse) candidate SSB locations. As an example, FIG. 12 depicts four candidate SSB locations that are defined over two slots, such as for a 30 kHz SCS. SSB locations may differ for other SCSs and/or for other frequency ranges. However, the reference signals may reuse the candidate SSB locations in a similar manner as described herein. As an example, the reference signal (for example, described in connection with reference number 915) may not be expected in subframes, slots, or OFDM symbols that are not otherwise associated with a candidate SSB location.

As an example, a candidate SSB location for an SSB 0 may include symbols 4 through 7 of a first slot or symbols 2 through 5 of the first slot. An RS 0 may be included in the first two symbols of the candidate SSB location for the SSB 0 (e.g., symbols 4 and 5 or symbols 2 and 3). An RS 1 may be included in the next two symbols of the candidate SSB location for the SSB 0 (e.g., symbols 6 and 7 or symbols 4 and 5). A candidate SSB location for an SSB 1 may include symbols 8 through 11 of the first slot. An RS 2 may be included in the first two symbols of the candidate SSB location for the SSB 1 (e.g., symbols 8 and 9). An RS 3 may be included in the next two symbols of the candidate SSB location for the SSB 1 (e.g., symbols 10 and 11).

A candidate SSB location for an SSB 2 may include symbols 2 through 5 of a second slot. An RS 4 may be included in the first two symbols of the candidate SSB location for the SSB 2 (e.g., symbols 2 and 3). An RS 5 may be included in the next two symbols of the candidate SSB location for the SSB 2 (e.g., symbols 4 and 5). A candidate SSB location for an SSB 3 may include symbols 6 through 9 of the second slot or symbols 8 through 11 of the second slot. An RS 6 may be included in the first two symbols of the candidate SSB location for the SSB 3 (e.g., symbols 6 and 7 or symbols 8 and 9). An RS 7 may be included in the next two symbols of the candidate SSB location for the SSB 0 (e.g., symbols 8 and 9 or symbols 10 and 11).

As indicated above, FIG. 12 is provided as an example. Other examples may differ from what is described with respect to FIG. 12.

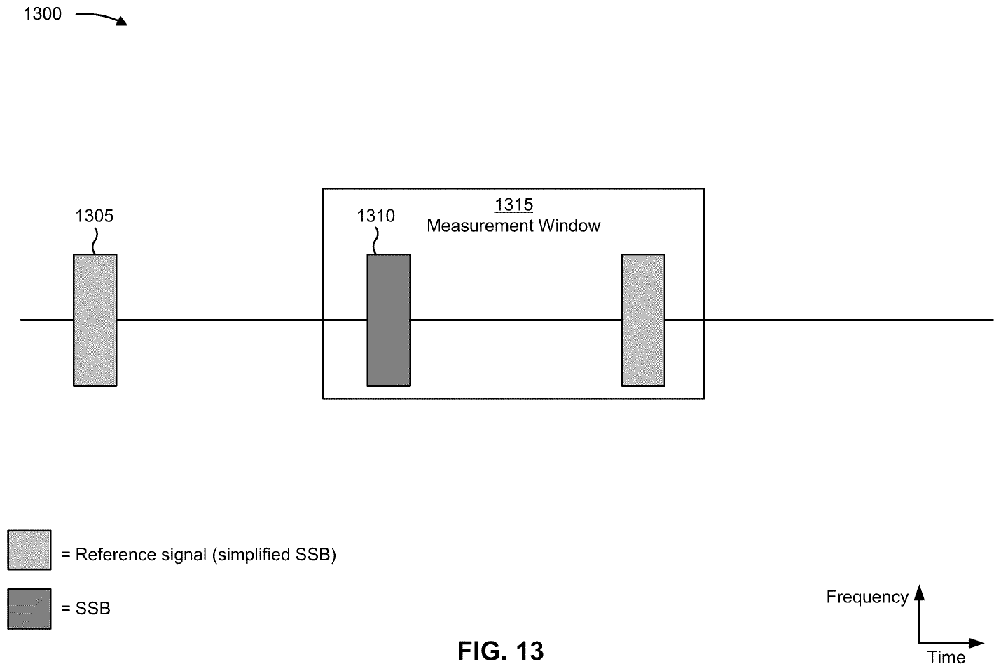

FIG. 13 is a diagram of an example 1300 associated with timing for a reference signal for on-demand broadcast communications, in accordance with the present disclosure. As shown in FIG. 13, a UE may receive a reference signal 1305. The reference signal may be similar to the reference signal described in connection with reference number 915, FIGS. 10A-10E, FIG. 11A-11B, and/or FIG. 12. For example, the reference signal 1305 may be an RS for on-demand broadcast communications.

The UE may receive a broadcast communication 1310, shown as an SSB in FIG. 13 as an example. The broadcast communication 1310 may be transmitted based on, in response to, or otherwise associated with a trigger, as described elsewhere herein. For example, the broadcast communication 1310 may be an on-demand broadcast communication. The UE may be configured to measure the broadcast communication 1310 during a measurement window 1315 (e.g., an SSB measurement window).

In some aspects, the UE may measure the reference signal 1305 during a first measurement window (e.g., an RS measurement window). The UE may measure the broadcast communication 1310 during a second measurement window (e.g., the measurement window 1315). A timing of the measurement window 1315 may be relative to the first measurement window. For example, the timing of the measurement window 1315 may be relative to an end of the first measurement window. For example, a start of measurement window 1315 may be X symbols or slots from the end of RS measurement window (e.g., the first measurement window). As another example, the timing of the measurement window 1315 may be relative to a slot in which the first measurement window occurs (e.g., if the UE is able to obtain slot timing information via the reference signal 1305, such as via a TSS). For example, the measurement window 1315 may occur P slots after the slot in which the first measurement window occurs.

As shown in FIG. 13, the reference signal 1305 and the broadcast communication 1310 may be transmitted via the same frequency. This may reduce UE complexity and/or latency associated with searching for the broadcast communication 1310. In some aspects, the first measurement window and/or the second measurement window (e.g., the measurement window 1315) may be configured on a cell-group basis (e.g., per cell-group). This may simplify detection for the reference signal 1305 and/or the broadcast communication 1310.

As indicated above, FIG. 13 is provided as an example. Other examples may differ from what is described with respect to FIG. 13.

FIG. 14 is a diagram illustrating an example process 1400 performed, for example, at a UE or an apparatus of a UE, in accordance with the present disclosure. Example process 1400 is an example where the apparatus or the UE (e.g., UE 120) performs operations associated with a reference signal for on-demand broadcast communications.

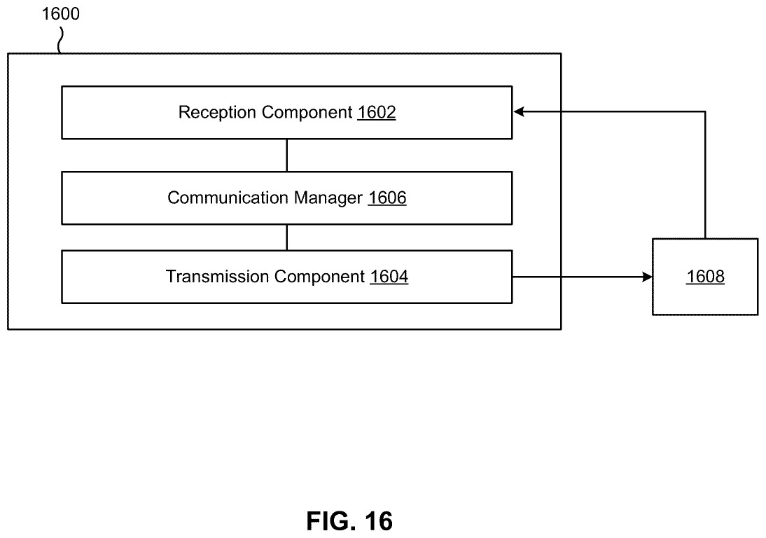

As shown in FIG. 14, in some aspects, process 1400 may include receiving an SSB configuration for SSBs that carry first synchronization information (block 1410). For example, the UE (e.g., using reception component 1602 and/or communication manager 1606, depicted in FIG. 16) may receive an SSB configuration for SSBs that carry first synchronization information, as described above.

As further shown in FIG. 14, in some aspects, process 1400 may include receiving a reference signal indicating second synchronization information that is reduced relative to the first synchronization information (block 1420). For example, the UE (e.g., using reception component 1602 and/or communication manager 1606, depicted in FIG. 16) may receive a reference signal indicating second synchronization information that is reduced relative to the first synchronization information, as described above.

As further shown in FIG. 14, in some aspects, process 1400 may include measuring the reference signal to obtain measurement information (block 1430). For example, the UE (e.g., using communication manager 1606, depicted in FIG. 16) may measure the reference signal to obtain measurement information, as described above.

As further shown in FIG. 14, in some aspects, process 1400 may include transmitting, in association with the measurement information, a communication (block 1440). For example, the UE (e.g., using transmission component 1604 and/or communication manager 1606, depicted in FIG. 16) may transmit, in association with the measurement information, a communication, as described above.

As further shown in FIG. 14, in some aspects, process 1400 may include receiving, based on the transmission of the communication, an SSB in accordance with the SSB configuration and the measurement of the reference signal (block 1450). For example, the UE (e.g., using reception component 1602 and/or communication manager 1606, depicted in FIG. 16) may receive, based on the transmission of the communication, an SSB in accordance with the SSB configuration and the measurement of the reference signal, as described above.

Process 1400 may include additional aspects, such as any single aspect or any combination of aspects described below and/or in connection with one or more other processes described elsewhere herein.

In a first aspect, the SSB is associated with an SSB location in a time domain and a first transmission pattern, and the reception of the reference signal includes receiving, in at least a portion of the SSB location, the reference signal using a second transmission pattern.

In a second aspect, alone or in combination with the first aspect, the first synchronization information includes PSS information, SSS information, and PBCH information, and the second synchronization information includes only the PSS information and the SSS information.

In a third aspect, alone or in combination with one or more of the first and second aspects, the second synchronization information indicates symbol timing information and a physical cell identifier.

In a fourth aspect, alone or in combination with one or more of the first through third aspects, the second synchronization information indicates slot timing information, an index of the reference signal, and a physical cell identifier.

In a fifth aspect, alone or in combination with one or more of the first through fourth aspects, the second synchronization information includes only PSS information and SSS information.

In a sixth aspect, alone or in combination with one or more of the first through fifth aspects, the second synchronization information further includes TSS information.

In a seventh aspect, alone or in combination with one or more of the first through sixth aspects, the SSB is associated with an SSB location in a time domain and a first transmission pattern, where the first transmission pattern indicates a first time domain location for a PSS, a second time domain location for an SSS, and a third time domain location for a PBCH, and the reception of the reference signal includes receiving, in at least a portion of the SSB location, at least the PSS and the SSS using a second transmission pattern.

In an eighth aspect, alone or in combination with one or more of the first through seventh aspects, the second transmission pattern includes the PSS in the first time domain location and the SSS in a fourth time domain location.

In a ninth aspect, alone or in combination with one or more of the first through eighth aspects, the second transmission pattern includes only the PSS in the first time domain location and the SSS in the second time domain location.

In a tenth aspect, alone or in combination with one or more of the first through ninth aspects, the reference signal includes a first reference signal and a second reference signal, and the first reference signal and the second reference signal are included in the SSB location.

In an eleventh aspect, alone or in combination with one or more of the first through tenth aspects, the second transmission pattern indicates that a first portion of the SSB location includes the first reference signal and a second portion of the SSB location includes the second reference signal.

In a twelfth aspect, alone or in combination with one or more of the first through eleventh aspects, the second transmission pattern indicates that a first portion of the SSB location includes PSSs for the first reference signal and the second reference signal and a second portion of the SSB location includes SSSs for the first reference signal and the second reference signal.

In a thirteenth aspect, alone or in combination with one or more of the first through twelfth aspects, the second transmission pattern includes the PSS in the first time domain location, the SSS in a fourth time domain location, and a TSS in at least one of the first time domain location or the fourth time domain location.

In a fourteenth aspect, alone or in combination with one or more of the first through thirteenth aspects, the PSS and the SSS are included in first one or more frequency domain resources of the reference signal and the TSS is included in second or more frequency domain resources of the reference signal.

In a fifteenth aspect, alone or in combination with one or more of the first through fourteenth aspects, the TSS is frequency division multiplexed with the PSS and the SSS.

In a sixteenth aspect, alone or in combination with one or more of the first through fifteenth aspects, the PSS, the SSS, and the TSS are time division multiplexed.

In a seventeenth aspect, alone or in combination with one or more of the first through sixteenth aspects, the reception of the reference signal includes receiving the reference signal via a frequency, and the reception of the SSB includes receiving the SSB via the frequency.

In an eighteenth aspect, alone or in combination with one or more of the first through seventeenth aspects, the measurement of the reference signal includes measuring the reference signal during a first measurement window.

In a nineteenth aspect, alone or in combination with one or more of the first through eighteenth aspects, process 1400 includes measuring the SSB during a second measurement window, where a timing of the second measurement window is relative to the first measurement window.

In a twentieth aspect, alone or in combination with one or more of the first through nineteenth aspects, the timing of the second measurement window is relative to an end of the first measurement window or relative to a slot in which the first measurement window occurs.

In a twenty-first aspect, alone or in combination with one or more of the first through twentieth aspects, the first measurement window and the second measurement window are configured for a cell group.

In a twenty-second aspect, alone or in combination with one or more of the first through twenty-first aspects, the communication includes a cell wakeup signal.

In a twenty-third aspect, alone or in combination with one or more of the first through twenty-second aspects, the reception of the reference signal is from a cell, and the transmission of the communication includes transmitting the cell wakeup signal to trigger the transmission of the SSB from the cell based on the measurement information satisfying one or more criteria.

In a twenty-fourth aspect, alone or in combination with one or more of the first through twenty-third aspects, the communication includes a measurement report that indicates the measurement information.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, at a network node or an apparatus of a network node, in accordance with the present disclosure. Example process 1500 is an example where the apparatus or the network node (e.g., network node 110) performs operations associated with a reference signal for on-demand broadcast communications.

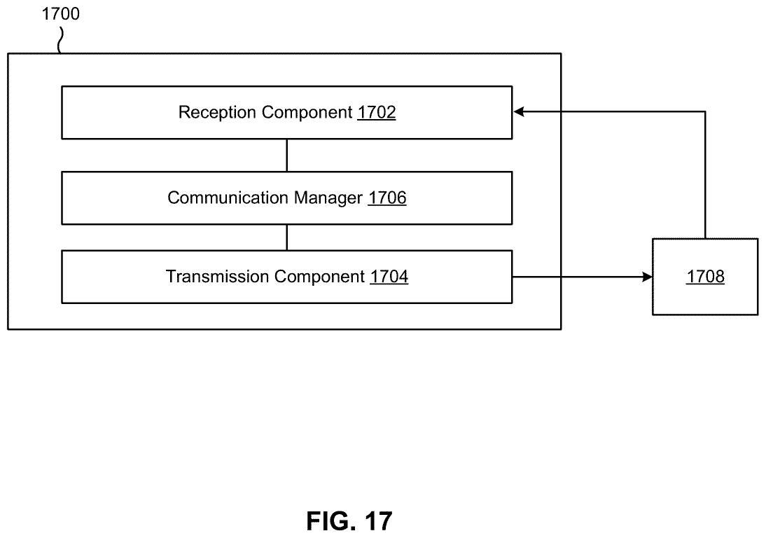

As shown in FIG. 15, in some aspects, process 1500 may include transmitting an SSB configuration for SSBs that carry first synchronization information (block 1510). For example, the network node (e.g., using transmission component 1704 and/or communication manager 1706, depicted in FIG. 17) may transmit an SSB configuration for SSBs that carry first synchronization information, as described above.

As further shown in FIG. 15, in some aspects, process 1500 may include transmitting a reference signal indicating second synchronization information that is reduced relative to the first synchronization information (block 1520). For example, the network node (e.g., using transmission component 1704 and/or communication manager 1706, depicted in FIG. 17) may transmit a reference signal indicating second synchronization information that is reduced relative to the first synchronization information, as described above.

As further shown in FIG. 15, in some aspects, process 1500 may include receiving, in association with measurement information of the reference signal, a communication (block 1530). For example, the network node (e.g., using reception component 1702 and/or communication manager 1706, depicted in FIG. 17) may receive, in association with measurement information of the reference signal, a communication, as described above.

As further shown in FIG. 15, in some aspects, process 1500 may include transmitting, based on the reception of the communication, an SSB, where the SSB is in accordance with the SSB configuration and the measurement information (block 1540). For example, the network node (e.g., using transmission component 1704 and/or communication manager 1706, depicted in FIG. 17) may transmit, based on the reception of the communication, an SSB, where the SSB is in accordance with the SSB configuration and the measurement information, as described above.

Process 1500 may include additional aspects, such as any single aspect or any combination of aspects described below and/or in connection with one or more other processes described elsewhere herein.

In a first aspect, the SSB is associated with an SSB location in a time domain and a first transmission pattern, and the transmission of the reference signal includes transmitting, in at least a portion of the SSB location, the reference signal using a second transmission pattern.

In a second aspect, alone or in combination with the first aspect, the first synchronization information includes PSS information, SSS information, and PBCH information, and the second synchronization information includes only the PSS information and the SSS information.

In a third aspect, alone or in combination with one or more of the first and second aspects, the second synchronization information indicates symbol timing information and a physical cell identifier.

In a fourth aspect, alone or in combination with one or more of the first through third aspects, the second synchronization information indicates slot timing information, an index of the reference signal, and a physical cell identifier.

In a fifth aspect, alone or in combination with one or more of the first through fourth aspects, the second synchronization information includes only PSS information and SSS information.

In a sixth aspect, alone or in combination with one or more of the first through fifth aspects, the second synchronization information further includes TSS information.

In a seventh aspect, alone or in combination with one or more of the first through sixth aspects, the SSB is associated with an SSB location in a time domain and a first transmission pattern, where the first transmission pattern indicates a first time domain location for a PSS, a second time domain location for an SSS, and a third time domain location for a PBCH, and the transmission of the reference signal includes transmitting, in at least a portion of the SSB location, at least the PSS and the SSS using a second transmission pattern.

In an eighth aspect, alone or in combination with one or more of the first through seventh aspects, the second transmission pattern includes the PSS in the first time domain location and the SSS in a fourth time domain location.

In a ninth aspect, alone or in combination with one or more of the first through eighth aspects, the second transmission pattern includes only the PSS in the first time domain location and the SSS in the second time domain location.

In a tenth aspect, alone or in combination with one or more of the first through ninth aspects, the reference signal includes a first reference signal and a second reference signal, and the first reference signal and the second reference signal are included in the SSB location.

In an eleventh aspect, alone or in combination with one or more of the first through tenth aspects, the second transmission pattern indicates that a first portion of the SSB location includes the first reference signal and a second portion of the SSB location includes the second reference signal.

In a twelfth aspect, alone or in combination with one or more of the first through eleventh aspects, the second transmission pattern indicates that a first portion of the SSB location includes PSSs for the first reference signal and the second reference signal and a second portion of the SSB location includes SSSs for the first reference signal and the second reference signal.

In a thirteenth aspect, alone or in combination with one or more of the first through twelfth aspects, the second transmission pattern includes the PSS in the first time domain location, the SSS in a fourth time domain location, and a TSS in at least one of the first time domain location or the fourth time domain location.

In a fourteenth aspect, alone or in combination with one or more of the first through thirteenth aspects, the PSS and the SSS are included in first one or more frequency domain resources of the reference signal and the TSS is included in second or more frequency domain resources of the reference signal.

In a fifteenth aspect, alone or in combination with one or more of the first through fourteenth aspects, the TSS is frequency division multiplexed with the PSS and the SSS.

In a sixteenth aspect, alone or in combination with one or more of the first through fifteenth aspects, the PSS, the SSS, and the TSS are time division multiplexed.

In a seventeenth aspect, alone or in combination with one or more of the first through sixteenth aspects, the transmission of the reference signal includes transmitting the reference signal via a frequency, and the transmission of the on-demand SSB includes transmitting the one or more SSB via the frequency.

In an eighteenth aspect, alone or in combination with one or more of the first through seventeenth aspects, process 1500 includes transmitting configuration information for a first measurement window for the reference signal and a second measurement window for the on-demand SSB, where a timing of the second measurement window is relative to the first measurement window.

In a nineteenth aspect, alone or in combination with one or more of the first through eighteenth aspects, the timing of the second measurement window is relative to an end of the first measurement window or relative to a slot in which the first measurement window occurs.

In a twentieth aspect, alone or in combination with one or more of the first through nineteenth aspects, the first measurement window and the second measurement window are configured for a cell group.

In a twenty-first aspect, alone or in combination with one or more of the first through twentieth aspects, the communication includes a cell wakeup signal, and the transmission of the on-demand SSB is in response to the reception of the cell wakeup signal.

In a twenty-second aspect, alone or in combination with one or more of the first through twenty-first aspects, the communication includes a measurement report that indicates the measurement information, and the transmission of the on-demand SSB is based on the measurement information satisfying one or more criteria.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE, or a UE may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 140 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 9, 10A-10E, 11A-11B, 12, and/or 13. Additionally, or alternatively, the apparatus 1600 may be configured to perform one or more processes described herein, such as process 1400 of FIG. 14, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1604 may be co-located with the reception component 1602 in one or more transceivers.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The reception component 1602 may receive an SSB configuration for SSBs that carry first synchronization information. The reception component 1602 may receive a reference signal indicating second synchronization information that is reduced relative to the first synchronization information. The communication manager 1606 may measure the reference signal to obtain measurement information. The transmission component 1604 may transmit, in association with the measurement information, a communication. The reception component 1602 may receive, based on the transmission of the communication, an SSB in accordance with the SSB configuration and the measurement of the reference signal.

The communication manager 1606 may measure the SSB during a second measurement window, wherein a timing of the second measurement window is relative to the first measurement window.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a network node, or a network node may include the apparatus 1700. In some aspects, the apparatus 1700 includes a reception component 1702, a transmission component 1704, and/or a communication manager 1706, which may be in communication with one another (for example, via one or more buses and/or one or more other components). In some aspects, the communication manager 1706 is the communication manager 150 described in connection with FIG. 1. As shown, the apparatus 1700 may communicate with another apparatus 1708, such as a UE or a network node (such as a CU, a DU, an RU, or a base station), using the reception component 1702 and the transmission component 1704.

In some aspects, the apparatus 1700 may be configured to perform one or more operations described herein in connection with FIGS. 9, 10A-10E, 11A-11B, 12, and/or 13. Additionally, or alternatively, the apparatus 1700 may be configured to perform one or more processes described herein, such as process 1500 of FIG. 15, or a combination thereof. In some aspects, the apparatus 1700 and/or one or more components shown in FIG. 17 may include one or more components of the network node described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1702 and/or the transmission component 1704 may include or may be included in a network interface. The network interface may be configured to obtain and/or output signals for the apparatus 1700 via one or more communications links, such as a backhaul link, a midhaul link, and/or a fronthaul link.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1708. In some aspects, the transmission component 1704 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1704 may be co-located with the reception component 1702 in one or more transceivers.

The communication manager 1706 may support operations of the reception component 1702 and/or the transmission component 1704. For example, the communication manager 1706 may receive information associated with configuring reception of communications by the reception component 1702 and/or transmission of communications by the transmission component 1704. Additionally, or alternatively, the communication manager 1706 may generate and/or provide control information to the reception component 1702 and/or the transmission component 1704 to control reception and/or transmission of communications.

The transmission component 1704 may transmit an SSB configuration for SSBs that carry first synchronization information. The transmission component 1704 may transmit a reference signal indicating second synchronization information that is reduced relative to the first synchronization information. The reception component 1702 may receive, in association with measurement information of the reference signal, a communication. The transmission component 1704 may transmit, based on the reception of the communication, an SSB, wherein the SSB is in accordance with the SSB configuration and the measurement information.

The transmission component 1704 may transmit configuration information for a first measurement window for the reference signal and a second measurement window for the on-demand SSB, wherein a timing of the second measurement window is relative to the first measurement window.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a user equipment (UE), comprising: receiving a synchronization signal block (SSB) configuration for SSBs that carry first synchronization information; receiving a reference signal indicating second synchronization information that is reduced relative to the first synchronization information; and measuring the reference signal to obtain measurement information; transmitting, in association with the measurement information, a communication; and receiving, based on the transmission of the communication, an SSB in accordance with the SSB configuration and the measurement of the reference signal.

Aspect 2: The method of Aspect 1, wherein the SSB is associated with an SSB location in a time domain and a first transmission pattern, and wherein the reception of the reference signal comprises: receiving, in at least a portion of the SSB location, the reference signal using a second transmission pattern.

Aspect 3: The method of any of Aspects 1-2, wherein the first synchronization information includes primary synchronization signal (PSS) information, secondary synchronization signal (SSS) information, and physical broadcast channel (PBCH) information, and wherein the second synchronization information includes only the PSS information and the SSS information.

Aspect 4: The method of any of Aspects 1-3, wherein the second synchronization information indicates symbol timing information and a physical cell identifier.

Aspect 5: The method of any of Aspects 1-4, wherein the second synchronization information indicates slot timing information, an index of the reference signal, and a physical cell identifier.

Aspect 6: The method of any of Aspects 1-5, wherein the second synchronization information includes only primary synchronization signal (PSS) information and secondary synchronization signal (SSS) information.

Aspect 7: The method of Aspect 6, wherein the second synchronization information further includes tertiary synchronization signal (TSS) information.

Aspect 8: The method of any of Aspects 1-7, wherein the SSB is associated with an SSB location in a time domain and a first transmission pattern, wherein the first transmission pattern indicates a first time domain location for a primary synchronization signal (PSS), a second time domain location for a secondary synchronization signal (SSS), and a third time domain location for a physical broadcast channel (PBCH), and wherein the reception of the reference signal comprises: receiving, in at least a portion of the SSB location, at least the PSS and the SSS using a second transmission pattern.

Aspect 9: The method of Aspect 8, wherein the second transmission pattern includes the PSS in the first time domain location and the SSS in a fourth time domain location.

Aspect 10: The method of any of Aspects 8-9, wherein the second transmission pattern includes only the PSS in the first time domain location and the SSS in the second time domain location.

Aspect 11: The method of any of Aspect 8-10, wherein the reference signal includes a first reference signal and a second reference signal, and wherein the first reference signal and the second reference signal are included in the SSB location.

Aspect 12: The method of Aspect 11, wherein the second transmission pattern indicates that a first portion of the SSB location includes the first reference signal and a second portion of the SSB location includes the second reference signal.

Aspect 13: The method of any of Aspect 11-12, wherein the second transmission pattern indicates that a first portion of the SSB location includes PSSs for the first reference signal and the second reference signal and a second portion of the SSB location includes SSSs for the first reference signal and the second reference signal.

Aspect 14: The method of any of Aspect 8-13, wherein the second transmission pattern includes the PSS in the first time domain location, the SSS in a fourth time domain location, and a tertiary synchronization signal (TSS) in at least one of the first time domain location or the fourth time domain location.

Aspect 15: The method of Aspect 14, wherein the PSS and the SSS are included in first one or more frequency domain resources of the reference signal and the TSS is included in second or more frequency domain resources of the reference signal.

Aspect 16: The method of any of Aspect 14-15, wherein the TSS is frequency division multiplexed with the PSS and the SSS.

Aspect 17: The method of any of Aspect 14-15, wherein the PSS, the SSS, and the TSS are time division multiplexed.

Aspect 18: The method of any of Aspects 1-17, wherein the reception of the reference signal comprises receiving the reference signal via a frequency, and wherein the reception of the SSB comprises receiving the SSB via the frequency.

Aspect 19: The method of any of Aspects 1-18, wherein the measurement of the reference signal comprises: measuring the reference signal during a first measurement window.

Aspect 20: The method of Aspect 19, further comprising: measuring the SSB during a second measurement window, wherein a timing of the second measurement window is relative to the first measurement window.

Aspect 21: The method of Aspect 20, wherein the timing of the second measurement window is relative to an end of the first measurement window or relative to a slot in which the first measurement window occurs.

Aspect 22: The method of any of Aspect 20-21, wherein the first measurement window and the second measurement window are configured for a cell group.

Aspect 23: The method of any of Aspects 1-22, wherein the communication includes a cell wakeup signal.

Aspect 24: The method of Aspect 23, wherein the reception of the reference signal is from a cell, and wherein the transmission of the communication comprises: transmitting the cell wakeup signal to trigger the transmission of the SSB from the cell based on the measurement information satisfying one or more criteria.

Aspect 25: The method of any of Aspects 1-24, wherein the communication includes a measurement report that indicates the measurement information.

Aspect 26: A method of wireless communication performed by a network node, comprising: transmitting a synchronization signal block (SSB) configuration for SSBs that carry first synchronization information; transmitting a reference signal indicating second synchronization information that is reduced relative to the first synchronization information; and receiving, in association with measurement information of the reference signal, a communication; and transmitting, based on the reception of the communication, an SSB, wherein the SSB is in accordance with the SSB configuration and the measurement information.

Aspect 27: The method of Aspect 26, wherein the SSB is associated with an SSB location in a time domain and a first transmission pattern, and wherein the transmission of the reference signal comprises: transmitting, in at least a portion of the SSB location, the reference signal using a second transmission pattern.

Aspect 28: The method of any of Aspects 26-27, wherein the first synchronization information includes primary synchronization signal (PSS) information, secondary synchronization signal (SSS) information, and physical broadcast channel (PBCH) information, and wherein the second synchronization information includes only the PSS information and the SSS information.

Aspect 29: The method of any of Aspects 26-28, wherein the second synchronization information indicates symbol timing information and a physical cell identifier.

Aspect 30: The method of any of Aspects 26-29, wherein the second synchronization information indicates slot timing information, an index of the reference signal, and a physical cell identifier.

Aspect 31: The method of any of Aspects 26-30, wherein the second synchronization information includes only primary synchronization signal (PSS) information and secondary synchronization signal (SSS) information.

Aspect 32: The method of Aspect 31, wherein the second synchronization information further includes tertiary synchronization signal (TSS) information.

Aspect 33: The method of any of Aspects 26-32, wherein the SSB is associated with an SSB location in a time domain and a first transmission pattern, wherein the first transmission pattern indicates a first time domain location for a primary synchronization signal (PSS), a second time domain location for a secondary synchronization signal (SSS), and a third time domain location for a physical broadcast channel (PBCH), and wherein the transmission of the reference signal comprises: transmitting, in at least a portion of the SSB location, at least the PSS and the SSS using a second transmission pattern.

Aspect 34: The method of Aspect 33, wherein the second transmission pattern includes the PSS in the first time domain location and the SSS in a fourth time domain location.

Aspect 35: The method of any of Aspect 33-34, wherein the second transmission pattern includes only the PSS in the first time domain location and the SSS in the second time domain location.

Aspect 36: The method of any of Aspect 33-35, wherein the reference signal includes a first reference signal and a second reference signal, and wherein the first reference signal and the second reference signal are included in the SSB location.

Aspect 37: The method of Aspect 36, wherein the second transmission pattern indicates that a first portion of the SSB location includes the first reference signal and a second portion of the SSB location includes the second reference signal.

Aspect 38: The method of any of Aspect 36-37, wherein the second transmission pattern indicates that a first portion of the SSB location includes PSSs for the first reference signal and the second reference signal and a second portion of the SSB location includes SSSs for the first reference signal and the second reference signal.

Aspect 39: The method of any of Aspect 33-38, wherein the second transmission pattern includes the PSS in the first time domain location, the SSS in a fourth time domain location, and a tertiary synchronization signal (TSS) in at least one of the first time domain location or the fourth time domain location.

Aspect 40: The method of Aspect 39, wherein the PSS and the SSS are included in first one or more frequency domain resources of the reference signal and the TSS is included in second or more frequency domain resources of the reference signal.

Aspect 41: The method of any of Aspect 39-40, wherein the TSS is frequency division multiplexed with the PSS and the SSS.

Aspect 42: The method of any of Aspect 39-40, wherein the PSS, the SSS, and the TSS are time division multiplexed.

Aspect 43: The method of any of Aspects 26-42, wherein the transmission of the reference signal comprises transmitting the reference signal via a frequency, and wherein the transmission of the on-demand SSB comprises transmitting the one or more SSB via the frequency.

Aspect 44: The method of any of Aspects 26-43, further comprising: transmitting configuration information for a first measurement window for the reference signal and a second measurement window for the on-demand SSB, wherein a timing of the second measurement window is relative to the first measurement window.

Aspect 45: The method of Aspect 44, wherein the timing of the second measurement window is relative to an end of the first measurement window or relative to a slot in which the first measurement window occurs.

Aspect 46: The method of any of Aspect 44-45, wherein the first measurement window and the second measurement window are configured for a cell group.

Aspect 47: The method of any of Aspects 26-46, wherein the communication includes a cell wakeup signal, and wherein the transmission of the on-demand SSB is in response to the reception of the cell wakeup signal.

Aspect 48: The method of any of Aspects 26-47, wherein the communication includes a measurement report that indicates the measurement information, and wherein the transmission of the on-demand SSB is based on the measurement information satisfying one or more criteria.

Aspect 49: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-48.

Aspect 50: An apparatus for wireless communication at a device, the apparatus comprising one or more memories and one or more processors coupled to the one or more memories, the one or more processors configured to cause the device to perform the method of one or more of Aspects 1-48.

Aspect 51: An apparatus for wireless communication, the apparatus comprising at least one means for performing the method of one or more of Aspects 1-48.

Aspect 52: A non-transitory computer-readable medium storing code for wireless communication, the code comprising instructions executable by one or more processors to perform the method of one or more of Aspects 1-48.

Aspect 53: A non-transitory computer-readable medium storing a set of instructions for wireless communication, the set of instructions comprising one or more instructions that, when executed by one or more processors of a device, cause the device to perform the method of one or more of Aspects 1-48.

Aspect 54: A device for wireless communication, the device comprising a processing system that includes one or more processors and one or more memories coupled with the one or more processors, the processing system configured to cause the device to perform the method of one or more of Aspects 1-48.

Aspect 55: An apparatus for wireless communication at a device, the apparatus comprising one or more memories and one or more processors coupled to the one or more memories, the one or more processors individually or collectively configured to cause the device to perform the method of one or more of Aspects 1-48.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A user equipment (UE) for wireless communication, comprising:
one or more memories; and
one or more processors, coupled to the one or more memories, configured to cause the UE to:
receive a synchronization signal block (SSB) configuration for SSBs that carry first synchronization information;
receive a reference signal indicating second synchronization information that is reduced relative to the first synchronization information; and
measure the reference signal to obtain measurement information;
transmit, in association with the measurement information, a communication; and
receive, based on the transmission of the communication, an SSB in accordance with the SSB configuration and the measurement of the reference signal.

2. The UE of claim 1, wherein the SSB is associated with an SSB location in a time domain and a first transmission pattern, and the one or more processors, to cause the UE to receive of the reference signal, are configured to cause the UE to:
receive, in at least a portion of the SSB location, the reference signal using a second transmission pattern.

3. The UE of claim 1, wherein the first synchronization information includes primary synchronization signal (PSS) information, secondary synchronization signal (SSS) information, and physical broadcast channel (PBCH) information, and
wherein the second synchronization information includes only the PSS information and the SSS information.

4. The UE of claim 1, wherein the second synchronization information indicates symbol timing information and a physical cell identifier.

5. The UE of claim 1, wherein the second synchronization information indicates slot timing information, an index of the reference signal, and a physical cell identifier.

6. The UE of claim 1, wherein the second synchronization information includes only primary synchronization signal (PSS) information and secondary synchronization signal (SSS) information.

7. The UE of claim 6, wherein the second synchronization information further includes tertiary synchronization signal (TSS) information.

8. The UE of claim 1, wherein the SSB is associated with an SSB location in a time domain and a first transmission pattern,
wherein the first transmission pattern indicates a first time domain location for a primary synchronization signal (PSS), a second time domain location for a secondary synchronization signal (SSS), and a third time domain location for a physical broadcast channel (PBCH), and
wherein the one or more processors, to cause the UE to receive of the reference signal, are configured to cause the UE to:
receive, in at least a portion of the SSB location, at least the PSS and the SSS using a second transmission pattern.

9. The UE of claim 8, wherein the second transmission pattern includes the PSS in the first time domain location and the SSS in a fourth time domain location.

10. The UE of claim 8, wherein the second transmission pattern includes only the PSS in the first time domain location and the SSS in the second time domain location.

11. A network node for wireless communication, comprising:
one or more memories; and
one or more processors, coupled to the one or more memories, configured to cause the network node to:
transmit a synchronization signal block (SSB) configuration for SSBs that carry first synchronization information;
transmit a reference signal indicating second synchronization information that is reduced relative to the first synchronization information; and
receive, in association with measurement information of the reference signal, a communication; and
transmit, based on the reception of the communication, an SSB, wherein the SSB is in accordance with the SSB configuration and the measurement information.

12. The network node of claim 11, wherein the SSB is associated with an SSB location in a time domain and a first transmission pattern, and wherein the one or more processors, to cause the network node to transmit of the reference signal, are configured to cause the network node to:
transmit, in at least a portion of the SSB location, the reference signal using a second transmission pattern.

13. The network node of claim 11, wherein the first synchronization information includes primary synchronization signal (PSS) information, secondary synchronization signal (SSS) information, and physical broadcast channel (PBCH) information, and
wherein the second synchronization information includes only the PSS information and the SSS information.

14. The network node of claim 11, wherein the second synchronization information indicates symbol timing information and a physical cell identifier.

15. The network node of claim 11, wherein the second synchronization information indicates slot timing information, an index of the reference signal, and a physical cell identifier.

16. A method of wireless communication performed by a user equipment (UE), comprising:
receiving a synchronization signal block (SSB) configuration for SSBs that carry first synchronization information;
receiving a reference signal indicating second synchronization information that is reduced relative to the first synchronization information; and
measuring the reference signal to obtain measurement information;
transmitting, in association with the measurement information, a communication; and
receiving, based on the transmission of the communication, an SSB in accordance with the SSB configuration and the measurement of the reference signal.

17. The method of claim 16, wherein the SSB is associated with an SSB location in a time domain and a first transmission pattern,
wherein the first transmission pattern indicates a first time domain location for a primary synchronization signal (PSS), a second time domain location for a secondary synchronization signal (SSS), and a third time domain location for a physical broadcast channel (PBCH), and
wherein the reception of the reference signal comprises:
receiving, in at least a portion of the SSB location, at least the PSS and the SSS using a second transmission pattern.

18. The method of claim 17, wherein the reference signal includes a first reference signal and a second reference signal, and wherein the first reference signal and the second reference signal are included in the SSB location.

19. The method of claim 18, wherein the second transmission pattern indicates that a first portion of the SSB location includes the first reference signal and a second portion of the SSB location includes the second reference signal.

20. The method of claim 18, wherein the second transmission pattern indicates that a first portion of the SSB location includes PSSs for the first reference signal and the second reference signal and a second portion of the SSB location includes SSSs for the first reference signal and the second reference signal.

21. The method of claim 17, wherein the second transmission pattern includes the PSS in the first time domain location, the SSS in a fourth time domain location, and a tertiary synchronization signal (TSS) in at least one of the first time domain location or the fourth time domain location.

22. The method of claim 21, wherein the PSS and the SSS are included in first one or more frequency domain resources of the reference signal and the TSS is included in second or more frequency domain resources of the reference signal.

23. The method of claim 21, wherein the TSS is frequency division multiplexed with the PSS and the SSS.

24. The method of claim 21, wherein the PSS, the SSS, and the TSS are time division multiplexed.

25. The method of claim 16, wherein the reception of the reference signal comprises receiving the reference signal via a frequency, and
wherein the reception of the SSB comprises receiving the SSB via the frequency.

26. The method of claim 16, wherein the measurement of the reference signal comprises:
measuring the reference signal during a first measurement window.

27. The method of claim 26, further comprising:
measuring the SSB during a second measurement window, wherein a timing of the second measurement window is relative to the first measurement window.

28. The method of claim 16, wherein the communication includes a cell wakeup signal.

29. The method of claim 16, wherein the communication includes a measurement report that indicates the measurement information.

30. A method of wireless communication performed by a network node, comprising:
transmitting a synchronization signal block (SSB) configuration for SSBs that carry first synchronization information;
transmitting a reference signal indicating second synchronization information that is reduced relative to the first synchronization information; and
receiving, in association with measurement information of the reference signal, a communication; and
transmitting, based on the reception of the communication, an SSB, wherein the SSB is in accordance with the SSB configuration and the measurement information.
